(19) United States
(12) Patent Application Publication
(10) Pub. No.: US 2026/0043710 A1
(43) Pub. Date: Feb. 12, 2026

(54) CORE ELEMENT IDENTIFICATION FOR HETEROGENEOUS MULTICORE OPTICAL FIBERS

(71) Applicant: CORNING INCORPORATED, CORNING, NY (US)

(72) Inventors: Douglas Llewellyn Butler, Painted Post, NY (US); Konrad Adam Wojtaszczyk, Widawa (PL)

(21) Appl. No.: 19/281,973

(22) Filed: Jul. 28, 2025

Related U.S. Application Data
(60) Provisional application No. 63/681,646, filed on Aug. 9, 2024.

(51) Int. Cl. G01M 11/00; G02B 6/02

(52) U.S. Cl. CPC G01M 11/37; G02B 6/02042

(57) ABSTRACT

Methods and algorithms are described herein for identifying core elements within a multicore optical fiber using single end-face image processing and/or lateral image processing. A method includes capturing a plurality of lateral images of the multicore optical fiber at various rotational orientations, determining an average intensity of each horizontal row from each of the lateral images, and compiling the average intensity of each of the plurality of horizontal rows into a plurality of datasets, each plurality of datasets corresponding to one of the lateral images. The plurality of datasets are compounded into a compounded image, a subset of the plurality of datasets is selected from the compounded image, and an image intensity of the subset of the plurality of datasets is analyzed. Based on the analysis, at least one structural component of each of at least two core elements present within the multicore optical fiber is identified.

This application claims the benefit of priority under 35 U.S.C. § 119 of U.S. Provisional Application Ser. No. 63/681,646 filed on Aug. 9, 2024, the content of which is relied upon and incorporated herein by reference in its entirety.

### FIELD

The present specification generally pertains to optical fibers. Specifically, the present specification relates to multicore optical fibers and, more particularly, to identifying individual core elements within heterogeneous multicore optical fibers using lateral image processing and/or end-face image processing.

### TECHNICAL BACKGROUND

Optical fibers are utilized in a variety of telecommunication applications. More specifically, multicore optical fibers are a type of optical fibers that include multiple core elements embedded in a common cladding. Each core element of a multicore optical fiber acts as an independent signal transmission channel. Since transmission capacity increases as the number of core elements in a multicore optical fiber increases, it is desirable to maximize the density of core elements in a given cross-sectional area of common cladding. Core element density can be increased by reducing the spacing between core elements.

Multicore optical fibers can be arranged in homogeneous or heterogeneous designs. In homogeneous multicore optical fibers, all core elements are identical. A multicore optical fiber is referred to as heterogeneous if at least two of the two or more core elements of the multicore optical fiber differ in refractive index, a core element dimension, and/or configuration of the core elements, for example.

A splicing process is used to join two distinct, or otherwise independent, optical fibers together to create one functioning optical fiber. More specifically, splicing is the process of connecting the endpoints of two or more fibers. Precise fiber alignment is necessary for accurate and/or reliable data transmission in an optical network, particularly when the cables include multicore optical fibers. As such, it is imperative for the core elements of each independent optical fiber to be rotationally aligned prior to splicing.

With the presence of multiple core elements within a multicore optical fiber it becomes difficult to track individual core elements along the length of the fiber and to determine the correspondence of core elements at one end of the fiber with core elements at the other end of the fiber. In cable deployments, for example, the fibers extend through jackets over long distances and are subjected to twists and turns over the length of the cable. As such, it is difficult to match core elements at one end of the cable with core elements at the other end of the cable. To enable identification of core elements, a marker element can be included in the common cladding of homogeneous multicore optical fibers. The marker element is used as an alignment reference (i.e., a datum) to enable determining the correspondence of core elements at opposite ends of the multicore optical fiber. The marker element is not typically used as a channel for transmitting an optical signal and is present solely for alignment purposes. The need for a marker element, however, complicates the manufacture of homogeneous multicore optical fibers with an added cost, for example, and is not always readily visible by a technician in the field performing the splicing.

As such, there is accordingly a need for a more reliable, cost-effective, and/or efficient process to identify core elements within multicore optical fibers, preferably without the need for inclusion of a separate marker element in the common cladding.

### SUMMARY

The present disclosure provides methods for identifying particular core elements within a multicore optical fiber. In various instances, the multicore optical fibers are heterogeneous multicore optical fibers having a plurality of core elements spaced throughout. In various instances, one or more of the plurality of core elements has a distinguishing characteristic from another of the plurality of core elements, such as different dimensions (e.g., diameter) of one or more regions of the core element, for example.

According to a first aspect A1, a method of identifying core elements within a multicore optical fiber is disclosed. The method includes capturing, by an imaging system, a first lateral image of a heterogeneous multicore optical fiber at a first rotational orientation, the first lateral image including a first plurality of horizontal rows, wherein the heterogeneous multicore optical fiber includes a first core element having a first core region surrounded by a first dedicated cladding region and a second core element having a second core region surrounded by a second dedicated cladding region. The first dedicated cladding region has a first diameter greater than a second diameter of the second dedicated cladding region. The method further includes determining, by a processor, a first average intensity of each of the first plurality of horizontal rows, compiling, by the processor, the first average intensity of each of the first plurality of horizontal rows in a first dataset, and capturing, by the imaging system, a second lateral image of the heterogeneous multicore optical fiber at a second rotational orientation, the first rotational orientation being different than the second rotational orientation, and the second lateral image including a second plurality of horizontal rows. The method further includes determining, by the processor, a second average intensity of each of the second plurality of horizontal rows, compiling, by the processor, the second average intensity of each of the second plurality of horizontal rows in a second dataset, and compounding, by the processor, the first dataset and the second dataset into a compounded image. The method further includes analyzing, by the processor, an image intensity of the compounded image against a vertical position of the image intensity in the compounded image and identifying, based on the analysis, the first core element having the first dedicated cladding region having the first diameter greater than the second diameter of the second dedicated cladding region of the second core element.

According to a second aspect A2, a method of identifying core elements within a heterogeneous multicore optical fiber is disclosed. The method includes capturing, by an imaging system, a plurality of lateral images of the heterogeneous multicore optical fiber at a plurality of rotational orientations, each lateral image of the plurality of lateral images comprising a plurality of horizontal rows, determining, by a processor, an average intensity of each of the plurality of horizontal rows from each of the plurality of lateral images, and compiling, by the processor, the average intensity of each of the plurality of horizontal rows from each of the plurality of lateral images into a plurality of datasets, each of the plurality of datasets corresponding to one of the plurality of lateral images. The method further includes compounding, by the processor, the plurality of datasets into a compounded image, selecting, by the processor, a subset of the plurality of datasets from the plurality of datasets compounded into the compounded image, and analyzing, by the processor, an image intensity of the compounded image against a vertical position of the image intensity in the compounded image of the subset of the plurality of datasets. The method further includes identifying, based on the comparison, a relative size of at least one structural component of each of at least two core elements present within the heterogeneous multicore optical fiber.

According to a third aspect A3, a method of identifying core elements within a multicore optical fiber is disclosed. The method may include capturing, by an imaging system, an end-face image of the multicore optical fiber, wherein the multicore optical fiber comprises at least two core elements surrounded by a common cladding and each of the at least two core elements has a core region surrounded by a dedicated cladding region. The method may further include estimating a location of a center of the core region of each of the at least two core elements. The method may further include determining a position of an outer edge of the core region of each of the at least two core elements. The method may further include determining a coordinate of the center of the core region of each of the at least two core elements using at least the determined position of the outer edge of the core region of each of the at least two core elements. The method may further include analyzing a radial intensity profile of each of the at least two core elements using at least in part the determined coordinate of the center of the core region of each of the at least two core elements. The method may further include identify one of the at least two core elements from another one of the at least two core elements based on the analysis of the radial intensity profile.

According to a fourth aspect A4, a method of identifying core elements within a multicore optical fiber is disclosed. The method includes capturing, by an imaging system, an end-face image of the multicore optical fiber, wherein the multicore optical fiber includes a plurality of core elements and each of the plurality of core elements has a core region surrounded by a dedicated cladding region, estimating a location of a center of each of the plurality of core elements, determining a position of an outer edge of each of the plurality of core elements, and determining a difference in a size of the dedicated cladding region of each of the plurality of core elements.

Additional features and advantages of the core element identification algorithms for multicore optical fibers described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A shows a cross-section of a multicore optical fiber with core elements arranged in a 1×2 configuration;

FIG. 1B shows a cross-section of a multicore optical fiber with core elements arranged in a 1×4 configuration;

FIG. 1C shows a cross-section of a multicore optical fiber with core elements arranged in a 2×2 configuration;

FIG. 1D shows a cross-section of a multicore optical fiber with core elements arranged in a 2×2 configuration with a marker element;

FIG. 2 shows a cross-section of a heterogeneous multicore optical fiber with core elements arranged in a 1×2 configuration;

FIG. 3-I shows a cross-section of a heterogeneous multicore optical fiber with core elements arranged in a 1×2 configuration and a captured lateral image in gray scale of the multicore optical fiber;

FIG. 3-II shows a line-drawing representation of FIG. 3-I, in particular, with the captured lateral image of the multicore optical fiber represented by a line drawing;

FIG. 4-I shows the captured lateral image of the multicore optical fiber of FIG. 3-I and a vertical 1×N dataset indicative of average intensities of each horizontal row of the captured lateral image;

FIG. 4-II shows a line-drawing representation of FIG. 4-I, in particular, with the captured lateral image and the vertical 1×N dataset represented by line drawings;

FIG. 5A-I shows the fiber of FIG. 3 in a first rotational orientation and a corresponding vertical 1×N dataset representing average gray scale intensities of a captured lateral image taken at the first rotational orientation;

FIG. 5A-II shows a line-drawing representation of FIG. 5A-I, in particular, with the vertical 1×N dataset represented by a line drawing;

FIG. 5B-I shows the fiber of FIG. 3 in a second rotational orientation and a corresponding vertical 1×N dataset representing average gray scale intensities of a captured lateral image taken at the second rotational orientation;

FIG. 5B-II shows a line-drawing representation of FIG. 5B-I, in particular, with the vertical 1×N dataset represented by a line drawing;

FIG. 5C-I shows the fiber of FIG. 3 in a third rotational orientation and a corresponding vertical 1×N dataset representing average gray scale intensities of a captured lateral image taken at the third rotational orientation;

FIG. 5C-II shows a line-drawing representation of FIG. 5C-I, in particular, with the vertical 1×N dataset represented by a line drawing;

FIG. 5D-I shows a plurality of vertical 1×N datasets, including the vertical 1×N datasets of FIGS. 5A-I, 5B-I, and 5C-I, compounded into an image over a plurality of full fiber rotations;

FIG. 5D-II shows a line-drawing representation of FIG. 5D-II, in particular, with the vertical 1×N datasets and the compounded image represented by line drawings;

FIG. 6-I shows select sparsely spaced vertical 1×N datasets and the compounded image of FIG. 5D-I as reference;

FIG. 6-II shows a line-drawing representation of FIG. 6-I, in particular, with the select 1×N datasets and the reference compounded image represented by a line drawing;

FIG. 7-I shows one technique for determining a core element identity based at least in part on shifting positions of the apexes of an intensity plot based on select vertical 1×N datasets of the compound image of FIG. 5C-I;

FIG. 7-II shows a line-drawing representation of FIG. 7-I, in particular, with the compounded image represented by a line drawing;

FIG. 8A shows a multicore optical fiber having a central axis extending therethrough;

FIG. 8B shows a location for a focal plane based at least in part on arrangement of a number of core elements within a multicore optical fiber;

FIG. 8C shows a location for a focal plane based at least in part on arrangement of a number of core elements within another multicore optical fiber;

FIG. 8D shows a location for a focal plane based at least in part on arrangement of a number of core elements within another multicore optical fiber;

FIG. 8E shows a location for a focal plane based at least in part on arrangement of a number of core elements within another multicore optical fiber;

FIG. 9A shows a process for determining a core element identity based on lateral image analysis;

FIG. 9B shows a process for determining a core element identity based on lateral image analysis;

FIG. 10A-I shows a captured end-face image of a heterogeneous multicore optical fiber with core elements arranged in a 1×2 configuration;

FIG. 10A-II shows a line-drawing representation of FIG. 10A-I;

FIG. 10B-I shows the captured end-face image of FIG. 10A-I after the image of FIG. 10A-I has been cropped;

FIG. 10B-II shows a line-drawing representation of FIG. 10B-I;

FIG. 10C-I shows the cropped image of FIG. 10B-I after an image uniformity of the image of FIG. 10B-I has been improved by noise reduction;

FIG. 10C-II shows a line-drawing representation of FIG. 10C-I;

FIG. 10D-I shows the image of FIG. 10C-I after edges of the fiber and/or core elements have been detected;

FIG. 10D-II shows a line-drawing representation of FIG. 10D-I;

FIG. 10E-I shows the image of FIG. 10D-I after coordinates of the core elements have been finely detected and marked;

FIG. 10E-II shows a line-drawing representation of FIG. 10E-I;

FIG. 11 shows various pathways for a light source to be directed for capturing the end-face image of FIG. 10A-I;

FIG. 12 shows a radial profile for an optical intensity of the image of each core element within the heterogeneous multicore optical fiber of FIG. 10A, the radial profiles obtained based on the image of FIG. 10C-I;

FIG. 13 shows a first derivative of each radial profile over the region of interest of FIG. 12 corresponding to each core element within the heterogeneous multicore optical fiber of FIG. 10A; and

FIG. 14 shows a process for determining a core element identity based on end-face image analysis.

### DETAILED DESCRIPTION

Reference will now be made in detail to embodiments of core element identification algorithms for multicore optical fibers, examples of which are illustrated in the accompanying drawings. Whenever possible, the same reference numerals will be used throughout the drawings to refer to the same or like parts. In embodiments, a method of identifying core elements within a heterogeneous multicore optical fiber may include capturing a plurality of lateral images of the multicore optical fiber at various rotational orientations, determining an average intensity of each horizontal row from each of the lateral images, and compiling the average intensity of each of the plurality of horizontal rows into a plurality of datasets, each plurality of datasets corresponding to one of the lateral images. The plurality of datasets are compounded into a compounded image, a subset of the plurality of datasets is selected from the compounded image, and an image intensity of the compounded image is compared. A relative size of at least one structural component of each of at least two core elements present within the multicore optical fiber is identified. Various embodiments of core element identification algorithms for heterogeneous multicore optical fibers will be described herein with specific reference to the appended drawings.

In this specification and in the claims that follow, reference will be made to a number of terms which shall be defined to have the following meanings:

“Include,” “includes,” “including”, or like terms means encompassing but not limited to, that is, inclusive and not exclusive.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise. The term “plurality” means two or more.

Directional terms as used herein—for example up, down, right, left, front, back, top, bottom—are made only with reference to the figures as drawn and the coordinate axis provided therewith and are not intended to imply absolute orientation.

As used herein, “directly adjacent” means directly contacting and “indirectly adjacent” mean indirectly contacting. The term “adjacent” encompasses elements that are directly or indirectly adjacent to each other.

“Optical fiber” refers to a waveguide having a glass portion surrounded by a coating. The glass portion is referred to herein as a “glass fiber”. The glass fiber of a single-core optical fiber consists of a single core region surrounded by one or more cladding regions, where the single core region and one or more cladding regions function collectively as a waveguide. The glass fiber of a multicore optical fiber includes two or more core elements surrounded by a common cladding, where each core element functions as a waveguide in the multicore optical fiber and each core element consists of a core region surrounded optionally by one or more dedicated cladding regions. A multicore optical fiber is referred to herein as “heterogeneous” if at least two of the two or more core elements of the multicore optical fiber differ in the value of the propagation constant β.

The “propagation constant” β of a core element corresponds to the change in phase of the guided mode in the core element per unit length of propagation of the guided mode in the core element. The “effective index” n_{eff} of a core element is the ratio of the propagation constant β of light with wavelength λ to the propagation constant β0 of light with wavelength λ in vacuum:

$${n}_{eff} = \frac{β}{{β}_{0}} where$$

$${β}_{0} = \frac{2 π}{λ}$$

For purposes of the present disclosure, the guided mode is the LP01 mode at a wavelength of 1550 nm, a wavelength at which the core elements described herein are single modes. For purposes of the present disclosure, the propagation constant β of a core element refers to the propagation constant of the core element in an isolated state in the common cladding region, free of coupling and crosstalk to other core elements.

“Relative refractive index,” as used herein, is defined in Eq. (1) as:

$$Δ ( r ) \% = 100 \frac{( {n}^{2} ( r ) - {n}_{ref}^{2} )}{2 {n}^{2} ( r )} \qquad ( 1 )$$

where n(r) is the refractive index at radial position r in the glass fiber, unless otherwise specified, and n_{ref} is the refractive index of pure silica glass, unless otherwise specified. For purposes of the present disclosure, n_{ref}=1.444, which is the refractive index of pure silica at 1550 nm. Accordingly, as used herein, the relative refractive index percent is relative to pure silica glass. As used herein, the relative refractive index is represented by Δ (or “delta”) or Δ % (or “delta %”) and its values are given in units of “%”, unless otherwise specified. Relative refractive index may also be expressed as Δ(r) or Δ(r) %. An analogous definition of relative refractive index can be expressed in terms of radial coordinate R.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

The present disclosure provides algorithms and/or processes used to determine an identity of a core element within a multicore optical fiber. For purposes of illustration, much of the disclosure that follows describes multicore optical fibers having two core elements. It should be apparent, however, that multicore optical fibers having more than two core elements are similarly contemplated and within the scope of the disclosure. The number of core elements in the multicore optical fiber is two or more, or three or more, or four or more, or six or more, or eight or more, or twelve or more, or sixteen or more, or between 2 and 32, or between 3 and 28, or between 4 and 24, or between 6 and 20, or between 8 and 16. The described processes can be used with any combination of core elements in multicore optical fibers.

Multicore optical fibers include two or more core elements. Each core element includes a core region and optionally includes one or more dedicated cladding regions. The multicore optical fiber also includes a cladding region common to at least two of the two or more core elements. The core regions and cladding regions are glass. Types of cladding regions include dedicated cladding regions and common cladding regions. A cladding region is said to be “dedicated” if it surrounds the core region of only one core element of the two or more core elements and is said to be “common” if it surrounds the core regions of at least two core elements of the two or more core elements. In embodiments described herein, the common cladding region surrounds two or more core elements of the multicore optical fiber. The dedicated and common cladding regions may include multiple regions that differ in relative refractive index.

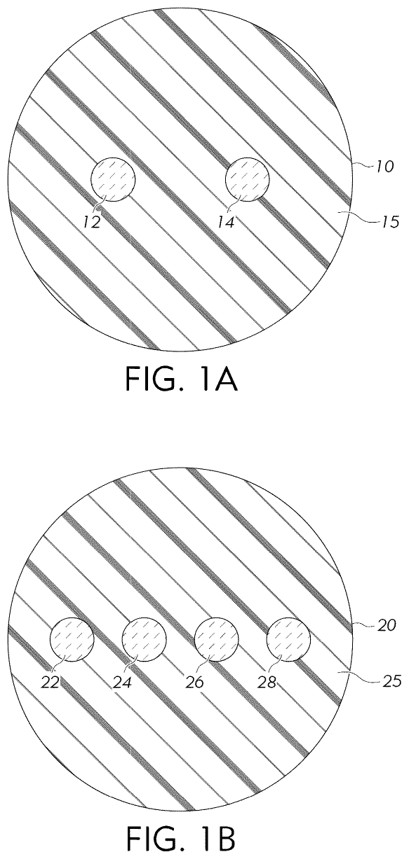

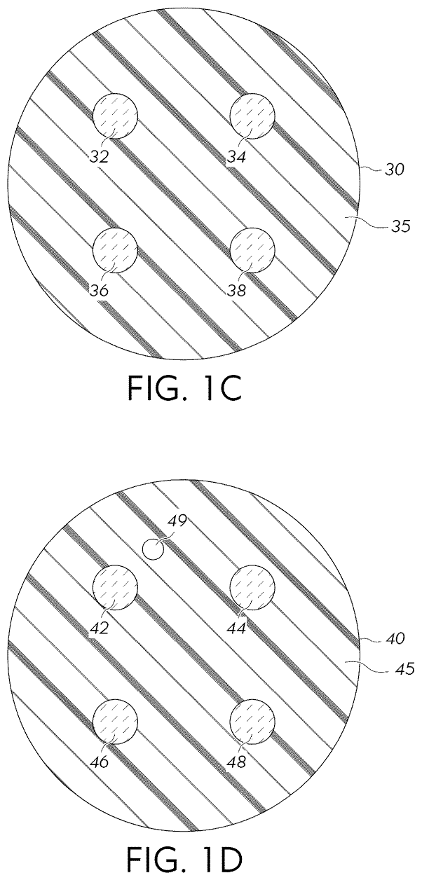

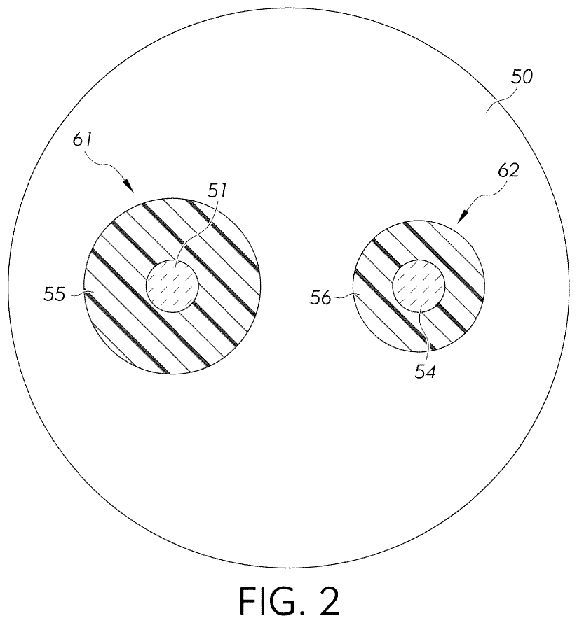

Various exemplary multicore optical fibers having various arrangements of core elements are shown in and described with respect to FIGS. 1A-2. For example, FIG. 1A shows a cross-section of a multicore optical fiber 10 with two core elements 12, 14 arranged in a 1×2 configuration in common cladding region 15. Core elements 12, 14 are symmetrically disposed about the centerline of the homogeneous multicore optical fiber. Although depicted as single regions, it is understood that core elements 12, 14 may include multiple regions such as one or more of a core region, dedicated inner cladding region, dedicated depressed index cladding region (also referred to as a “trench”), and dedicated outer cladding region, for example.

FIG. 1B shows a cross-section of a multicore optical fiber 20 with four core elements 22, 24, 26, 28 arranged in a 1×4 configuration in common cladding region 25. Core elements 22, 24, 26, 28 are symmetrically disposed about the centerline of the multicore optical fiber. Although depicted as single regions, it is understood that core elements 22, 24, 26, 28 may include multiple regions as described herein such as one or more of a core region, dedicated inner cladding region, dedicated depressed index cladding region (also referred to as a “trench”), and dedicated outer cladding region, for example.

FIG. 1C shows a cross-section of a multicore optical fiber 30 with four core elements 32, 34, 36, 38 arranged in a 2×2 configuration in common cladding region 35. Core elements 32, 34, 36, 38 are symmetrically disposed about the centerline of the multicore optical fiber. Although depicted as single regions, it is understood that core elements 32, 34, 36, 38 may include multiple regions such as one or more of a core region, dedicated inner cladding region, dedicated depressed index cladding region (also referred to herein as a “trench”), and dedicated outer cladding region, for example.

When deployed in a cable, multicore optical fibers may extend for several hundred meters or kilometers within a jacket. During stranding or installation of the multicore optical fiber in the jacket, the multicore optical fiber may be subjected to twisting or rotation about the centerline. The extent of twisting or rotation is typically not known and not readily determinable, so it is not visually, or otherwise readily, possible to determine which core element at one end of the multicore optical fibers corresponds to which core element at the opposite end of the multicore optical fibers.

To enable identification of core elements, a marker element is customarily included in homogeneous multicore optical fibers having a symmetric arrangement of core elements; however, marker elements can also be included in heterogeneous multicore optical fibers and/or homogeneous multicore optical fibers having an asymmetric arrangement of core elements, for example. FIG. 1D shows a variation of the multicore optical fiber of FIG. 1C that includes a marker element 49. More specifically, FIG. 1D shows a cross-section of a multicore optical fiber 40 with four core elements 42, 44, 46, 48 arranged in a 2×2 configuration in common cladding region 45. The marker element 49 is disposed in the common cladding region 45 adjacent the core element 42 and extends along the length of the multicore optical fiber 40. The marker element serves as an alignment reference that is detectable at both ends of the multicore optical fiber. The marker element 49 allows for identification and correspondence of core elements 42, 44, 46, 48 at two, opposing ends of the multicore optical fiber 40.

The use of marker elements does not come without practical consequences. For example, one drawback of using a marker element as an alignment reference is the additional complexity it adds to the fiber manufacturing process. The marker element is an additional component that needs to be integrated into the common cladding region of the multicore optical fiber along with the core elements. Adding a marker element into an optical fiber during the manufacturing process is costly. Moreover, the marker element is often difficult to visually detect by a technician in the field.

Heterogeneous multicore optical fibers include at least two core elements that differ with respect to composition, dimension, and/or structure. Such difference(s) can be used to distinguish the different core elements of a heterogeneous multicore optical fiber in the absence of a marker element. For example, any asymmetric arrangement of core elements that differ in one or more of composition, dimension, and/or structure enables determination of alignment and correspondence of core elements on opposite ends of the heterogeneous multicore optical fiber through inspection of the ends of the heterogeneous multicore optical fiber. An asymmetric arrangement refers to any arrangement of core elements that lacks rotational symmetry with respect to all angles of rotation about the centerline of the heterogeneous multicore optical fiber. While such difference(s) can be used to distinguish the different core elements in the absence of a marker element, oftentimes such differences are not readily apparent to a technician in the field, for example.

FIG. 2, for example, shows one of many possible examples of a heterogeneous variant 50 of the multicore optical fiber of FIG. 1A. As in FIG. 1A, the heterogeneous core elements 61, 62 are arranged in a 1×2 configuration. In some embodiments, the centerlines of the core elements 61, 62 may be symmetrically disposed about the centerline of the heterogeneous multicore optical fiber. In some embodiments, the centerlines of the core elements 61, 62 may not be symmetrically disposed about the centerline of the heterogeneous multicore optical fiber. The core elements 61, 62 may not be identical. In some embodiments, the core elements 61, 62 may differ with respect to at least one or composition, dimension, structure, disposition/placement with respect to the centerline of the heterogeneous multicore optical fiber, etc. The core element 61 includes a core region 52 which is surrounded by a first dedicated cladding region 55, and the core element 62 includes a core region 54 which is surrounded by a second dedicated cladding region 56, for example. In some embodiments, at least one of the dedicated cladding regions 55, 56 may be a dedicated depressed cladding region or trench region having a relative refractive index less than the adjacent core region and/or the common cladding regions. In some embodiments, the core region 52, the first dedicated cladding region 55, the core region 54, the second dedicated cladding region 56, and/or the multicore optical fiber include circular cross sections. In some embodiments, the outer diameter of the first dedicated cladding region 55 of the core element 61 may be different, for example, greater, than the outer diameter of the second dedicated cladding region 56 of the core element 62. Accordingly, the core element 61 may include a greater diameter than the core element 62, for example. Alternative heterogeneous multicore optical fiber elements are described in greater detail in U.S. Provisional Patent Application Ser. No. 63/605,125, entitled “MULTICORE OPTICAL FIBER WITH HETEROGENEOUS CORE ELEMENTS,” the contents of which is hereby incorporated by reference in its entirety.

Achieving an accurate alignment of heterogeneous multicore optical fibers during a splicing process is necessary for ensuring accurate and/or reliable data transmission in an optical network. Splicing equipment typically includes one or more camera systems for capturing lateral images, one or more camera systems for capturing end-face images, or one or more camera systems for capturing both lateral and end-face images of the heterogeneous multicore optical fibers being spliced. However, such splicing equipment typically relies on an ability to detect visually-identifying features, such as a presence of a marker or a significant difference in core element size, for example, for a user to be able to determine if a desired alignment has been reached between the two ends of the multicore optical fibers. Enhanced algorithms, such as the algorithms described herein, can be incorporated into any splicing equipment, including retrofit into existing splicing equipment by being downloaded, for example, into a memory of the splicing equipment for a processor associated with the splicing equipment to execute to automatically identify particular core elements, and their associated rotational orientations, within the multicore optical fiber. In various instances, splicing equipment includes a memory and a processor. The memory, such as a non-transitory, processor-readable storage medium, may be configured for storing computer executable components such as an image processing algorithm. The processor may facilitate operation of the computer executable components.

More specifically, methods for identifying core elements through image processing are disclosed herein that utilize one or more lateral images of the multicore optical fiber taken across a range of rotational orientations and/or an end-face image. As described in greater detail herein, such methods are applicable for various types of heterogeneous multicore optical fiber arrangements, such as those described herein, and other heterogeneous multicore optical fibers as described in greater detail in U.S. Provisional Patent Application Ser. No. 63/605,125, entitled “MULTICORE OPTICAL FIBER WITH HETEROGENEOUS CORE ELEMENTS,” the contents of which is hereby incorporated by reference in its entirety.

In at least one instance, core elements of a heterogeneous multicore optical fiber can be differentiated using lateral image processing, as described in further detail herein. A lateral image, as described herein, provides a visual perspective from a side of an object, such as a multicore optical fiber. Stated another way, the lateral image provides a visual perspective along a length of the object. In various instances, the length may be less than one millimeter. Such a length is short enough to ensure that no fiber twisting exists in the length of the fiber captured within the lateral image.

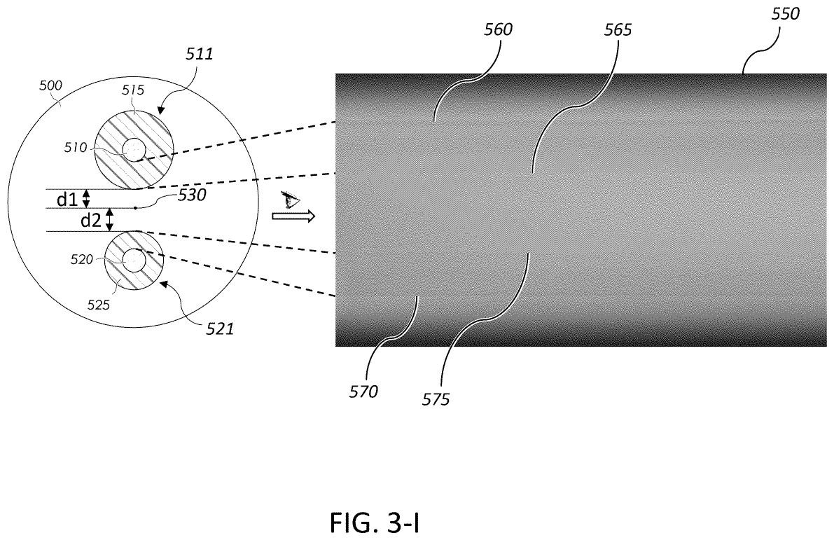

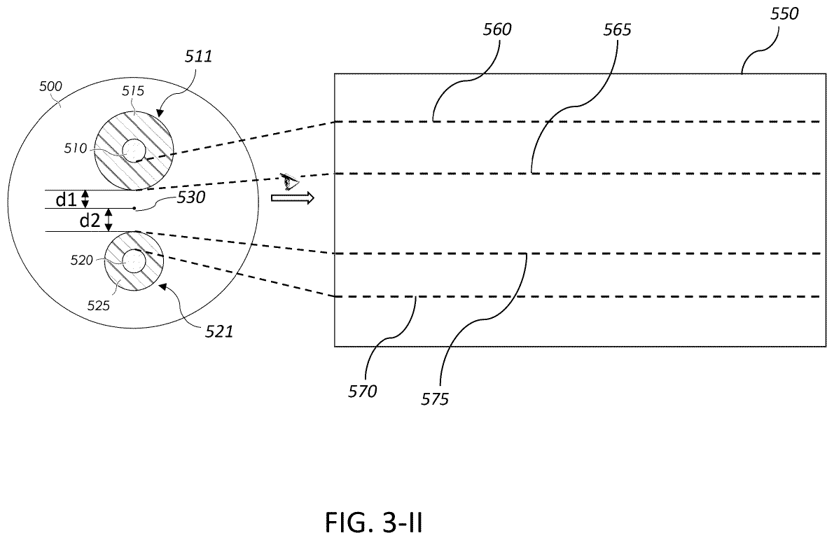

Referring now to FIGS. 3-I through 7-II, an embodiment of a method for identifying the individual core elements of a heterogeneous multicore optical fiber using lateral image processing is illustrated. While described as a method or process, it should be understood that the method may be embodied in an algorithm which may be executed by optical fiber splicing equipment. FIGS. 3-I and 3-II depict a cross-section of a heterogeneous multicore optical fiber 500 with two core elements 511, 521 arranged in a 1×2 configuration. The first core element 511 includes a first core region 510 which is surrounded by a first dedicated cladding region 515. The second core element 521 includes a second core region 520 which is surrounded by a second dedicated cladding region 525. In some embodiments, the first core region 510, the first dedicated cladding region 515, the second core region 520, the second dedicated cladding region 525, and/or the heterogeneous multicore optical fiber 500 include circular cross sections. A first distance d₁ extends between an outer edge of the first dedicated cladding region 515 and the centerline 530 of the heterogeneous multicore optical fiber 500. A second distance d₂ extends between an outer edge of the second dedicated cladding region 525 and the centerline 530 of the heterogeneous multicore optical fiber 500. The first distance d₁ is different than the second distance d₂, and in the depicted instance of FIGS. 3-I and 3-II, the first distance d₁ is less than the second distance d₂.

In some embodiments, the difference between the first distance d₁ and the second distance d₂ may be at least in part due to the dimensional difference between the first core element 511 and the second core element 522. For example, in some embodiments, the outer radius/diameter of the first dedicated cladding region 515 may be different from, such as greater than, the outer radius/diameter of the second dedicated cladding region 525, resulting the edge of the first dedicated cladding region 515 to be closer to the centerline 530 of the heterogeneous multicore optical fiber 500 than the edge of the second dedicated cladding region 525. In some embodiments, the difference between the first distance d₁ and the second distance d₂ may be at least in part due to the disposition/displacement of the first core element 511 and the second core element 522 within the centerline 530 of the heterogeneous multicore optical fiber 500. For example, in some embodiments, the first core element 511 and second core element 521 may be disposed in the heterogeneous multicore optical fiber 500 in a manner such that the edge of the first dedicated cladding region 515 may be closer to the centerline 530 of the heterogeneous multicore optical fiber 500 than the edge of the second dedicated cladding region 525 while the first core element 511 and the second core element 521 may or may not be of the same size/dimension. For example, in some embodiments, the first dedicated cladding region 515 of the first core element 511 and the second dedicated cladding region 525 of the second core element 521 may have the same outer radius while the first core element 511 and the second core element 521 may be asymmetrically disposed with respect to the centerline 530 of the heterogeneous multicore optical fiber 500, resulting the difference between the first distance d₁ and the second distance d₂.

In some embodiments, the first dedicated cladding region 515 may be a depressed-index cladding region or trench region having a relative refractive index that may be lower than the relative refractive index of the common cladding region and/or the relative refractive index of the first core region 510. In some embodiments, the second dedicated cladding region 525 may be a depressed-index cladding region or trench region having a relative refractive index that may be lower than the common cladding region and/or the relative refractive index of the second core region 515. However, it should be noted that the present disclosure is not limited to identification of heterogeneous core elements having dedicated cladding regions immediately surrounded by the common cladding or to identification of heterogeneous core elements having core regions immediately surrounded by a dedicated cladding region. Each core region may be surround by one or more dedicated cladding regions each of which may or may not be a depressed-index cladding region, and further, the outermost dedicated cladding region of each core element may or may not be a depressed-index cladding region. The present disclosure may be used for identification of any of such heterogeneous core elements, whether the core elements differ from each other due to variations in the core region and/or one or more of the dedicated cladding regions. For example, although the methods and processes are described using the exemplary fiber shown in FIGS. 3-I and 3-II having substantially the same core region dimension but much different dedicated cladding region dimensions, the present disclosure can be used to identify heterogeneous core elements having different core region dimensions, alternative or in addition to different dedicated cladding region dimensions. As will be discussed in more detail below, the present disclosure may be employed to identify boundaries between adjacent regions, such as the boundary between the core region and an adjacent dedicated cladding region, or the boundary between two adjacent dedicated cladding regions, the boundary between the core region and an adjacent common cladding region when no dedicated cladding region is present, or the boundary between the outermost dedicated cladding region of a core element and the surrounding common cladding, etc. An absolute difference between the relative refractive indices of the adjacent regions may be less than or equal to (i.e., ≤) 1.5%, ≤1%, ≤0.5%, ≤0.3%, ≤0.1%, or less, or may range from about 0.1% to about 1.5%, from about 0.1% to about 1.2%, from about 0.1% to about 1%, from about 0.1% to about 0.8%, from about 0.1% to about 0.5%, from about 0.1% to about 0.3%, or from about 0.1% to about 0.2%, and the methods and processes described herein may be utilized to identify the boundaries therebetween, thereby distinguishing the heterogenous core elements. Further, since the boundaries between adjacent regions can be identified by the methods and processes described herein, the methods and processes described herein may be utilized to distinguish heterogenous core elements that may or may not have different core element dimensions but have different dispositions/placements with respect to the centerline 530 of the heterogeneous multicore optical fiber 500.

To identify individual core elements of the heterogeneous multicore optical fiber 500 and thereby properly orient the optical fiber for splicing, the lateral imaging system of a splicer, such as a Fujikura FSM-100P+ splicer, for example, is used to capture a lateral image 550 of the multicore optical fiber 500, as also shown in FIGS. 3-I and 3-II, at a particular rotational orientation of the heterogeneous multicore optical fiber 500. Notably, FIG. 3-I depicts the captured lateral image in gray scale while FIG. 3-II depicts a line-drawing representation of the captured lateral image. The lateral image 550 is taken along an axis that is substantially perpendicular to the cross-section of the heterogeneous multicore optical fiber 500. The captured lateral image 550 depicts various gray scale intensities of the multicore optical fiber 500 in horizontal rows, with select horizontal rows emphasized in FIG. 3-II with dashed lines 560, 565, 570, 575. Each horizontal row is defined by a height, such as, for example, one pixel in some embodiments or multiple pixels in other embodiments, from the lateral image 550. At least one of the horizontal rows, such as horizontal rows 560, 565, 570, 575, can be identified by discontinuities in the gray scale in the captured lateral image corresponding to refractive index changes in the multicore optical fiber.

Such horizontal rows or discontinuities in the gray scale present in the captured lateral image can correspond to features of the multicore optical fiber 500 such as one or more boundaries between any of the core regions and its adjacent dedicated cladding region or between any of the dedicated cladding regions and the common cladding, for example. In various instances, only a portion of an axial length of the multicore optical fiber 500 is captured in the captured lateral image 550. It is also noted that top and bottom portions of the initial lateral image taken are cropped, and thus, not included in the lateral image 550 shown in FIGS. 3-I and 3-II. The cropped top and bottom portions correspond to top and bottom peripheral regions of the heterogeneous multicore optical fiber 500 in that particular orientation that are shown as dark regions in the initial lateral image taken. These dark regions are removed for clarity and illustration purposes. However, cropping/removal of the top and bottom portions of the initial lateral image taken are not required for utilizing the methods and processes described herein to successfully identify the core elements of the heterogeneous multicore optical fiber.

With continued reference to FIGS. 3-I and 3-II, a first horizontal line 560 detectable in the captured lateral image 550 corresponds to the outer edge of the first core region 510. Notably, the first horizontal line 560 representing the outer edge of the first core region 510 in the captured lateral image 550 corresponds to a point on the outer edge of the first core region 510 that is positioned nearest the centerline 530 of the heterogeneous multicore optical fiber 500. A second horizontal line 565 detectable in the captured lateral image 550 corresponds to the outer edge of the first dedicated cladding region 515. Similarly, the second horizontal line 565 representing the outer edge of the first dedicated cladding region 515 in the captured lateral image 550 corresponds to a point on the outer edge of the first dedicated cladding region 515 that is positioned nearest the centerline 530 of the heterogeneous multicore optical fiber 500. A third horizontal line 570 detectable in the captured lateral image 550 corresponds to the outer edge of the second core region 520, more specifically, the point on the outer edge of the second core region 520 that is positioned nearest the centerline 530 of the heterogeneous multicore optical fiber 500. A fourth horizontal line 575 detectable in the captured lateral image 550 corresponds to the outer edge of the second dedicated cladding region 525, more specifically, the point on the outer edge of the second dedicated cladding region 525 that is positioned nearest the centerline 530 of the heterogeneous multicore optical fiber 500.

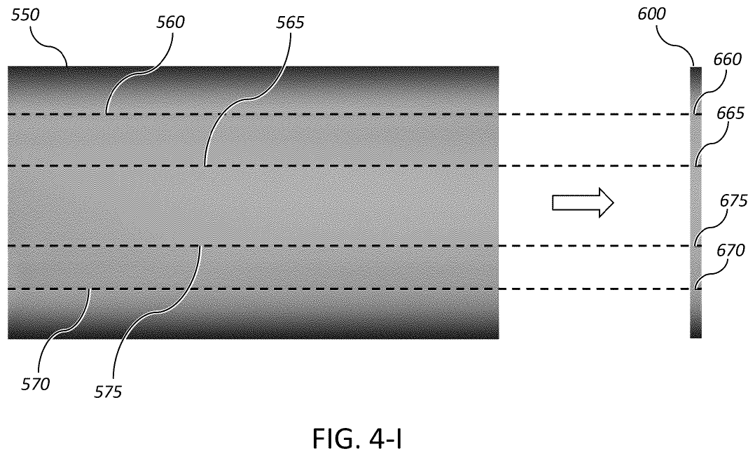

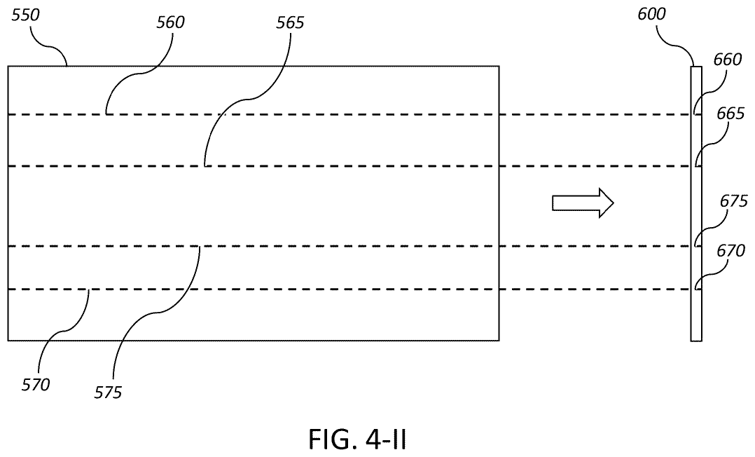

As the structure of the heterogeneous multicore optical fiber 500 is essentially unchanged along the length of the fiber, an average gray scale intensity is determined along each horizontal row. Such average gray scale intensities for the captured lateral image 550 are compiled into a single, vertical 1×N dataset 600, as shown in FIGS. 4-I and 4-II, for example. Notably, FIG. 4-I depicts the vertical 1×N dataset 600 in gray scale while a line-drawing representation of the vertical 1×N dataset 600 is shown in FIG. 4-II. The dimension N of the dataset corresponds to the N horizontal rows in the captured lateral image. A first horizontal line 660 detectable in the dataset 600 corresponds to an average gray scale intensity of the first horizontal line 560 detectable in the captured lateral image 550. A second horizontal line 665 detectable in the dataset 600 corresponds to an average gray scale intensity of the second horizontal line 565 detectable in the captured lateral image 550. Similarly, a third horizontal line 670 detectable in the dataset 600 corresponds to an average gray scale intensity of the third horizontal line 570 detectable in the captured lateral image 550 while a fourth horizontal line 675 detectable in the dataset 600 corresponds to an average gray scale intensity of the fourth horizontal line 575 detectable in the captured lateral image 550.

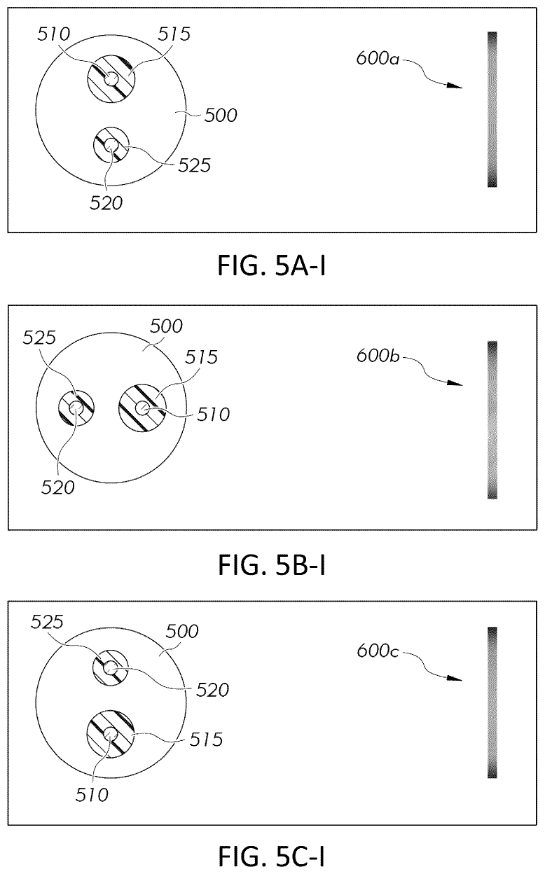

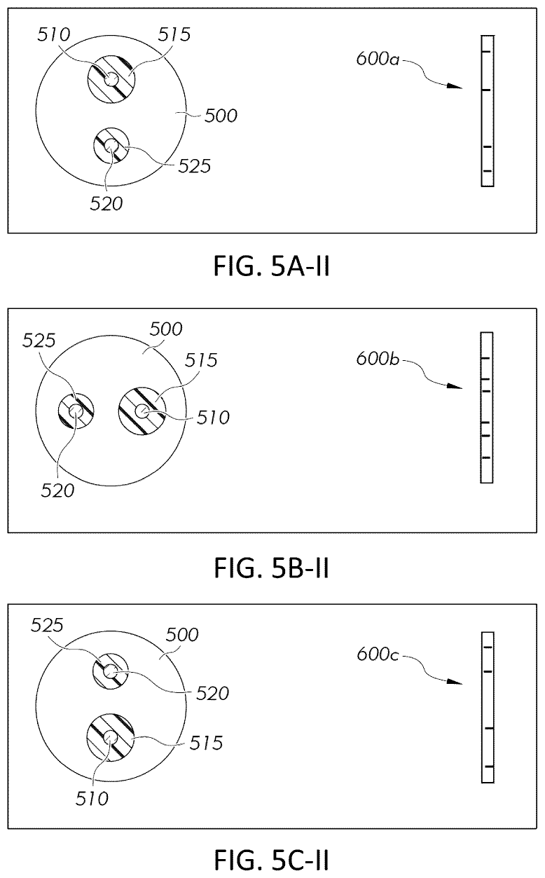

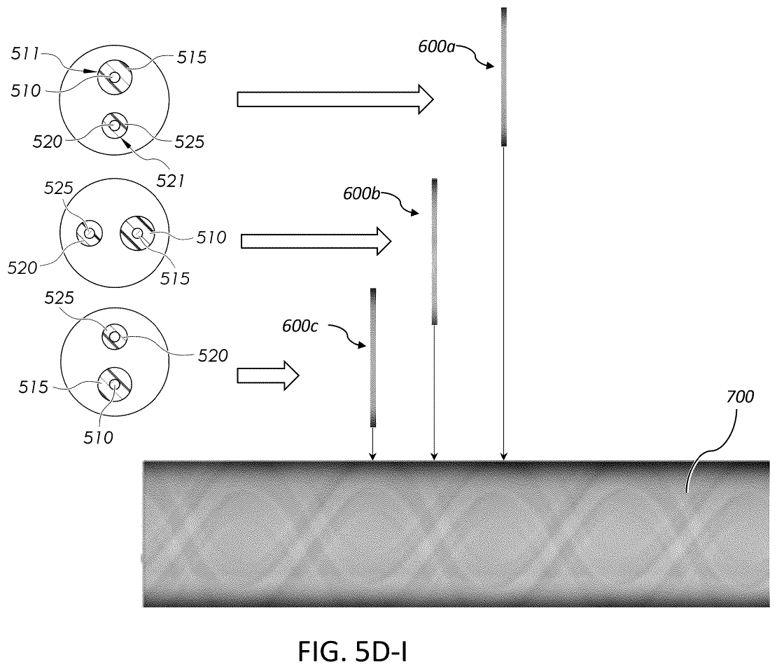

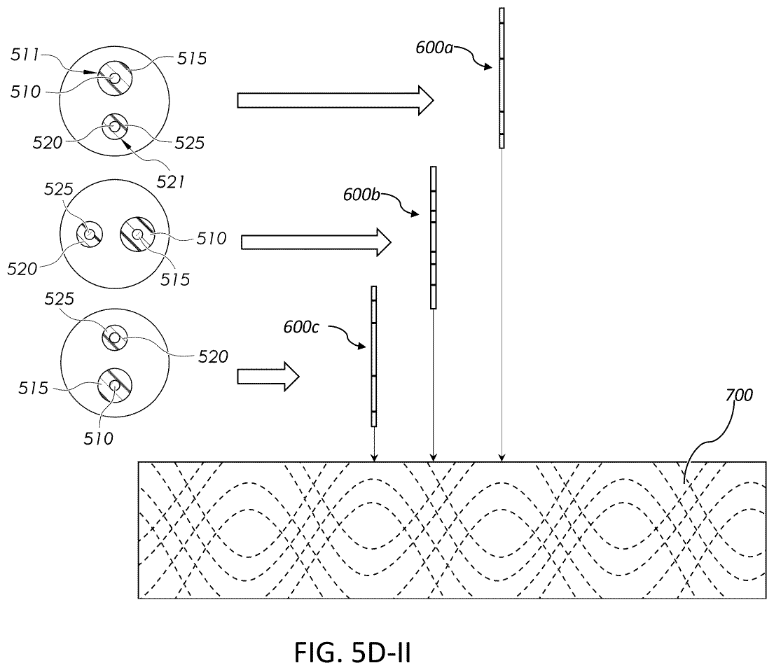

The process of capturing images and creating average intensity datasets is repeated for numerous different rotational orientations of the multicore optical fiber 500. FIGS. 5A-I and 5A-II show the heterogeneous multicore optical fiber 500 in the first rotational orientation as shown in FIGS. 3I and 3II and the corresponding vertical 1×N dataset 600a (same as the vertical 1×N dataset 600 shown in FIGS. 4-I and 4-II), while FIGS. 5B-I, 5B-II, 5C-I, and 5C-II show additional rotational orientations of the heterogeneous multicore optical fiber 500 for capturing additional images (e.g., a second lateral image, a third lateral image, etc.), similar to the first lateral image 550. An average gray scale intensity is determined along each horizontal row of each additional captured lateral image and compiled into a single, vertical 1×N dataset 600b, 600c, etc., for each additional captured lateral image. Thus, the dataset 600b reflects the average grayscale intensities of the multicore optical fiber 500 at a second rotational orientation. The second rotational orientation is different than the particular rotational orientation of the multicore optical fiber 500 for the first lateral image 550. Moreover, the dataset 600c reflects the average gray scale intensities of the multicore optical fiber 500 at a third rotational orientation. Notably, FIGS. 5A-I, 5B-I, and 5C-I show the vertical 1×N datasets in gray scale while FIGS. 5A-II, 5B-II, and 5C-II show the line-drawing representations of the vertical 1×N datasets.

After a desired number of datasets (600a-600n, similar in many respects to the datasets 600a, 600b, 600c) are collected, such datasets are compounded, or otherwise compiled, into a compounded image 700 as shown in FIGS. 5D-I through 7. FIG. 5D-I shows the compounded image 700 in gray scale while FIG. 5D-II shows a line-drawing representation of the compounded image 700. Notably, the compounded image 700 shown in FIGS. 5D-I and 5D-II shows a correspondence between the datasets 600a, 600b, 600c shown in FIGS. 5A-I, 5B-I, 5C-I, 5A-II, 5B-II, and 5C-II and their location on the compounded image 700.

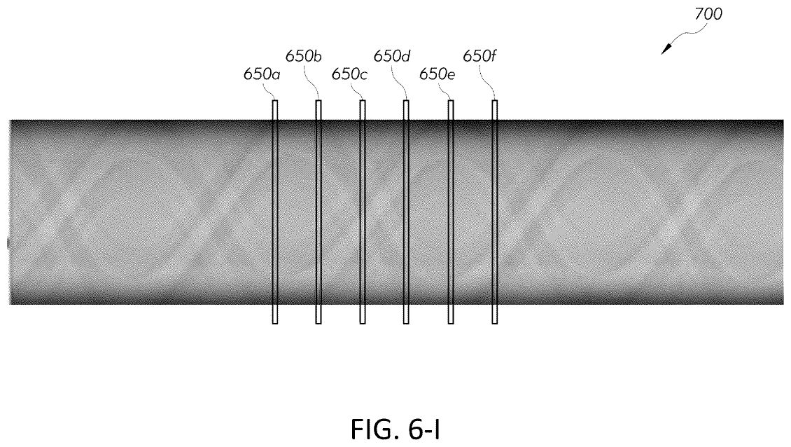

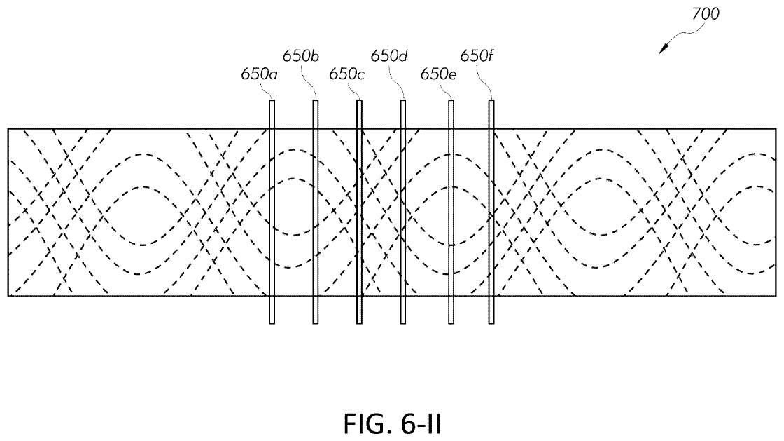

While datasets can be captured at rotational orientations spanning every 0.2°, such frequency is not necessary to achieve the desired result. For example, a total of 4,500 images can be captured at different rotational orientations of the fiber resulting in the creation of 4,500 single, vertical 1×N datasets. However, in practice, only a handful of images, such as less than ten, less than fifty, or less than one hundred images are needed over approximately a 180° span of rotation of the fiber about its central axis to determine an identity of each core element 511, 521. In various instances, it may not be necessary to compile any more datasets than would normally be used to rotationally align fibers in a splicer utilizing conventional techniques. For example, referring to FIGS. 6-I and 6-II, instead of forming the entire compounded image 700, only a few 1×N datasets, such as exemplary 1×N datasets 650a, 650b, 650c, 650d, 650e, 650f, may be needed for core elements identification. FIG. 6-I shows the vertical 1×N datasets and the compounded image 700 in gray scale while FIG. 6-II shows a line-drawing representation of FIG. 6-I. It is noted that the compounded image 700 is also shown in FIGS. 6-1 and 6-II for reference purpose to illustrate the rotational orientations at which the lateral images may be taken to generate the 1×N datasets, such as 1×N datasets 650a, 650b, 650c, 650d, 650c, 650f. In some embodiments, the 1×N datasets may be generated from lateral images taken over a particular range with regular or varying rotational intervals. In some embodiments, the 1×N datasets may be generated from lateral images taken at rotational orientations corresponding to the peaks and valleys of the compounded image 700 shown in FIGS. 6-1 and 6-II. In some embodiments, when the 1×N datasets may be generated from lateral images taken at rotational orientations corresponding to the peaks and valleys of the compounded image 700, a single 1×N dataset, such as the 1×N dataset 650e, generated from one single lateral image, may be sufficient to identify the core elements, as will be discussed in more detail below.

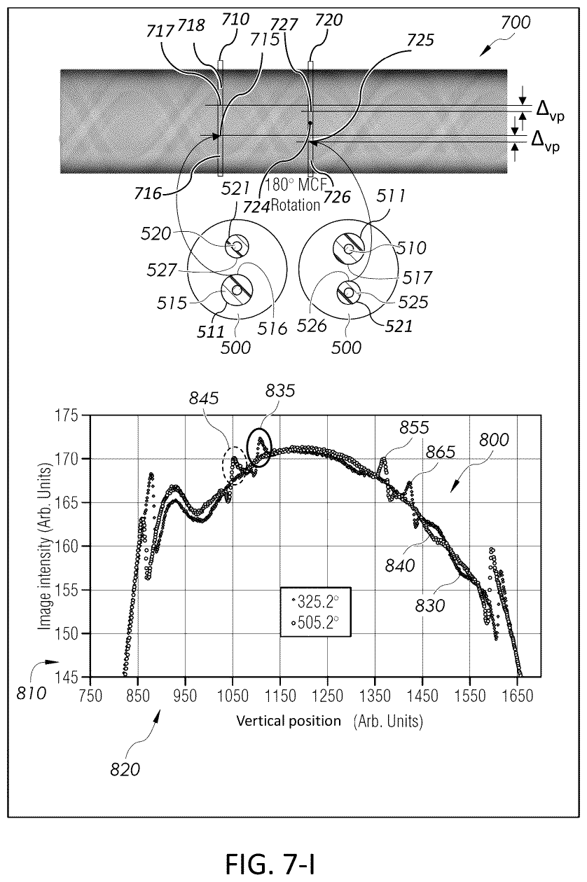

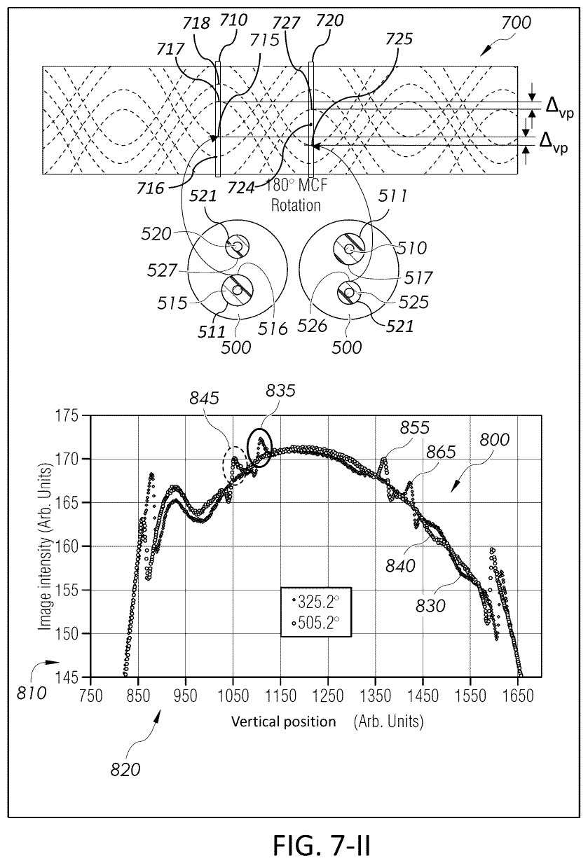

Once the compounded image 700 is obtained or only a limited number of datasets, such as datasets 650a, 650b, 650c, 650d, 650c, 650f, are obtained, one or more dataset slices may be selected and analyzed to distinguish the core elements. For example, as shown in FIGS. 7-I and 7-II, dataset slices 710, 720 at the peaks and valleys of the compounded image 700 at 180° rotation apart may be selected and analyzed for identification of the core elements. More specifically, the dataset slice 710 is generated from the lateral image taken at 325.2 degrees of fiber rotation from a start of the rotation process while the dataset slice 720 is generated from the lateral image taken at 505.2 degrees of fiber rotation from the start of the rotation process.

To identify or distinguish the core elements, image intensity 810 of each of datasets 710, 720 is plotted (i.e., plot 800 in FIGS. 7-I and 7-II), or otherwise analyzed by the processor, as a function of vertical position 820 in the compounded image 700. The plot 800 depicts two curves 830, 840. Curve 830 is an intensity curve plotted from the single vertical slice 710, and curve 840 is an intensity curve plotted from the single vertical slice 720. Such a plot 800 shows the shifting positions of each of the points 516, 517, 526, 527 on the outer edges of the dedicated cladding regions 515, 525 that are positioned nearest the centerline 530 (shown in FIGS. 3-I and 3-II) of the heterogeneous multicore optical fiber 500, graphically depicted as apexes 835, 845 of the curves 830, 840. Such shifting positions can be used to distinguish the core elements 511, 521 from one another. More specifically, the apex 835 corresponds to a geometrical position 516 of the first core element 511 where an interior surface (i.e., the surface closer to the centerline of the heterogeneous multicore optical fiber) of the first dedicated cladding region 515 ends and an adjacent layer, such as a layer of different cladding material, or more specifically the common cladding in the example shown in FIGS. 7-I and 7-II, begins, whereas the apex 845 corresponds to a geometrical position 526 of the second core element 521 where an interior surface (i.e., the surface closer to the centerline of the heterogeneous multicore optical fiber) of the second dedicated cladding region 525 ends and an adjacent layer, such as the common cladding in the example shown in FIGS. 7-I and 7-II, begins. The geometrical position 516 further corresponds to the apex 715 of the dataset slice 710, while the geometrical position 526 further corresponds to the apex 725 of the dataset slice 720, as explained previously with reference to FIGS. 3-I and 3-II above.

Distinguishing between image intensity, the processor represents the apex 715 of the compounded image 700 on the plot 800 as apex 835, whereas the apex 725 of the compounded image 700 is represented on the plot 800 as apex 845. Stated another way, the apex 835 corresponds to the first core element 511 having the outer edge of the first dedicated cladding region 515 closer to the centerline of the heterogeneous multicore optical fiber 500 as the vertical position associated with the apex 835 is greater than the vertical position associated with the apex 845 corresponding to the second core element 521 having the outer edge of the second dedicated cladding region 525 further away from the centerline of the heterogeneous multicore optical fiber 500. The vertical positional difference between the apex 835 and apex 845 is also illustrated as Δvp in the compound image 700.

While other apexes are present on the plot 800, such apexes convey various intensity discontinuities not created where a common cladding meets the dedicated cladding region on a bottom half of the compounded image 700. More specifically, apexes 855, 865 located to the right of the apexes 835, 845 convey various intensity discontinuities created where the common cladding meets the dedicated cladding region on a top half of the compounded image 700. For example, apex 855 corresponds to a geometrical position 517 of the first core element 511 where an interior surface (i.e., the surface closer to the centerline of the heterogeneous multicore optical fiber) of the first dedicated cladding region 515 ends and an adjacent layer, such as a layer of different cladding material, or more specifically the common cladding in the example shown in FIGS. 7-I and 7-II, begins, whereas the apex 865 corresponds to a geometrical position 527 of the second core element 521 where an interior surface (i.e., the surface closer to the centerline of the heterogeneous multicore optical fiber) of the second dedicated cladding region 525 ends and an adjacent layer, such as the common cladding in the example shown in FIGS. 7-I and 7-II, begins. The geometrical position 517 further corresponds to the apex 727 of the dataset slice 720, while the geometrical position 527 further corresponds to the apex 717 of the dataset slice 710. The vertical positional difference between the apex 855 and apex 865 is also illustrated as Δvp in the compound image 700.

The vertical positional difference Δvp is at least in part due to the difference between the distance d₁ and the distance d₂ (Δd=d₂−d₁) described above with reference to FIGS. 3-I and 3-II above. It is noted that the process described herein may be capable of distinguishing the core elements from one another when the difference Ad between the distance d₁ and the distance d₂ may be less than or equal to (i.e., ≤) 10 μm, ≤9 μm, ≤8 μm, ≤7 μm, ≤6 μm, 5 μm, ≤4.5 μm, ≤4 μm, ≤3.5 μm, ≤3 μm, ≤2.5 μm, ≤2 μm, ≤1.5 μm, ≤1 μm, ≤0.75 μm, ≤0.5 μm, 0.25 μm, ≤0.1 μm, or less.

While analysis of two 1×N datasets 710, 720 is described herein for identifying the core elements as a non-limiting exemplary process, in some embodiments, it is possible to use one 1×N dataset for identify one core element, such as a core element disposed closer to the centerline of the heterogeneous multicore optical fiber (e.g., the core element 511), from another core element, such as a core element disposed further away from the centerline of the heterogeneous multicore optical fiber (e.g., the core element 521). For example, using 1×N dataset 720, the identification of the core elements 511, 521 involves a comparison of a distance between the apex 727 and the midpoint 724 of the 1×N dataset 720 and a distance between the apex 725 and the midpoint 724. The larger distance corresponds to the core element 521, and the smaller distance corresponds to the core element 511. The 1×N dataset 710 may also be used in a similar manner to identify the core elements 511, 521.

As another example, in some embodiments, it is possible to identify one core element, such as a core element with a larger dedicated cladding region width (e.g., the core element 511), from another core element, such as a core element with a smaller dedicated cladding region width (e.g., the core element 521), using a single 1×N dataset. For example, using dataset 710, the identification of the core elements 511, 521 involves a comparison of a distance between the apex 717 and apex 718 and a distance between the apex 715 and the apex 716. The larger distance corresponds to the core element 511, and the smaller distance corresponds to the core element 521. The 1×N dataset 720 may also be used in a similar manner to identify the core elements 511, 521.

Further, it is noted that while the process is described using an exemplary heterogeneous multicore optical fiber 500 having core elements 511, 521 the outer edges of which are disposed at different distances d₁ and d₂ from the centerline 530 of the heterogeneous multicore optical fiber 500, the process described herein may also be utilized for identifying core elements that have the same outer diameter and/or are disposed equal-distant from the centerline 530 but have different core region diameters. Such difference in the core region diameters may be identified using, for example, apex 716 and apex 718 of the 1×N dataset 710.

It should be understood that the foregoing analysis utilizes output images captured, or otherwise produced, using the imaging capabilities (i.e., the imaging system) of commercial splicers and the associated memory and processors thereof. In various instances, the processor can be an internal component of the commercial splicer. In other instances, the processor can be remote to the commercial splicer in the form of a computer, for example.

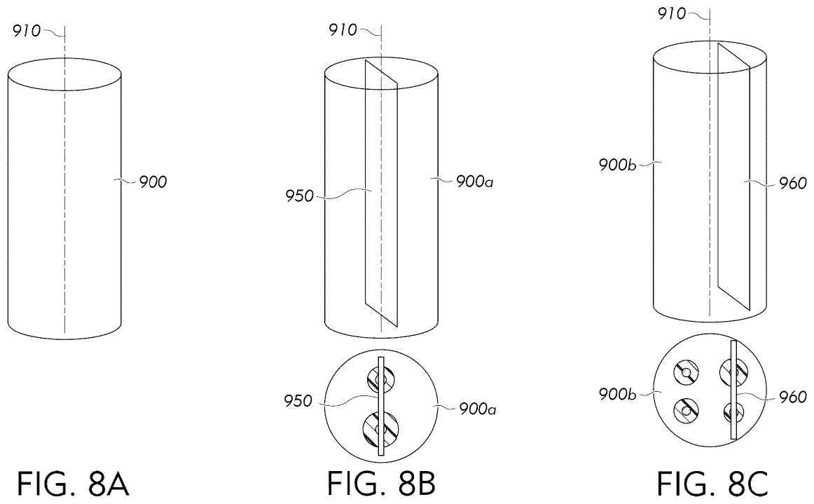

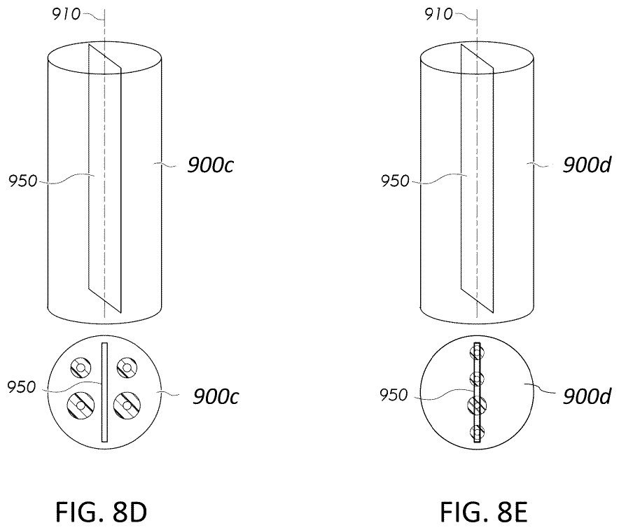

While the core identification process using lateral image processing is described in the context of a multicore optical fiber with two core elements in a 1×2 arrangement, such a core element identification process can be utilized with multicore optical fibers having any number of core elements in any arrangement. As depicted in FIG. 8A, a central axial line 910 extends through a multicore optical fiber 900. Notably, the captured image 550 (FIGS. 3-1, 3-II, 4-I, and 4-II) may be taken with a focal plane 950 of the camera, or imaging system, set to a center of the fiber and is therefore focused on the central axial line of the fiber. More specifically, as shown in FIG. 8B, the placement of the focal plane 950 parallel to the central axial line 910 of the multicore optical fiber 900a works well for multicore optical fibers with a 1×2 core element arrangement, as the focal plane 950 extends through a center point of both core elements. Alternate multicore optical fiber arrangements, such as the multicore optical fiber 900b, may require placing the focal plane 960 away from the central axial line 910, for example, as depicted in FIG. 8C. Moving the focal plane 960 away from the central axial line 910 of the multicore optical fiber 900b may be optimal for certain heterogeneous multicore optical fiber configuration, such as the 2×2 core element arrangement as shown in FIG. 8C, for example, as the new placement of the focal plane 960 can extend through a center point of two adjacent core elements. FIG. 8D shows another 2×2 core element arrangement of a multicore optical fiber 900c where the focal plane 950 may be positioned parallel to the central axial line 910 of the multicore optical fiber 900c. FIG. 8E shows a further 2×2 core element arrange of a multicore optical fiber 900d where the focal plane 950 may also be positioned parallel to the central axial line 910 of the multicore optical fiber 900d.

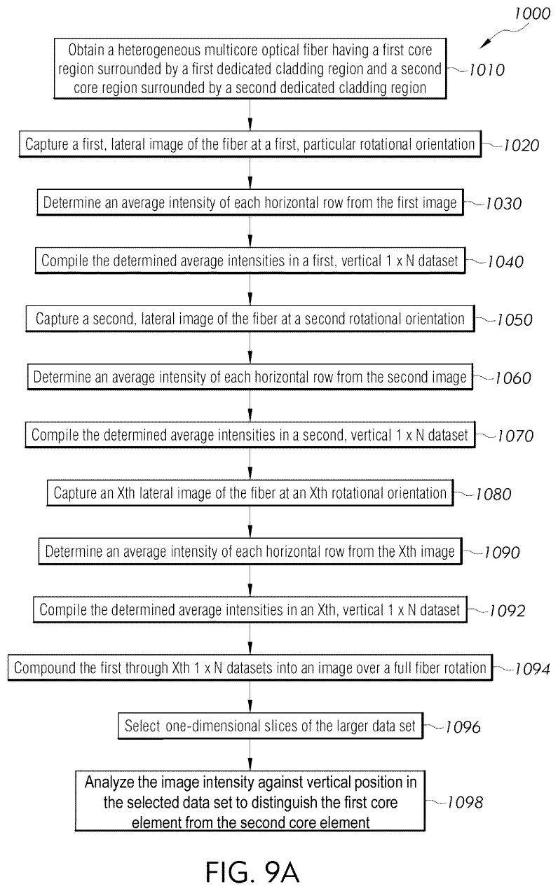

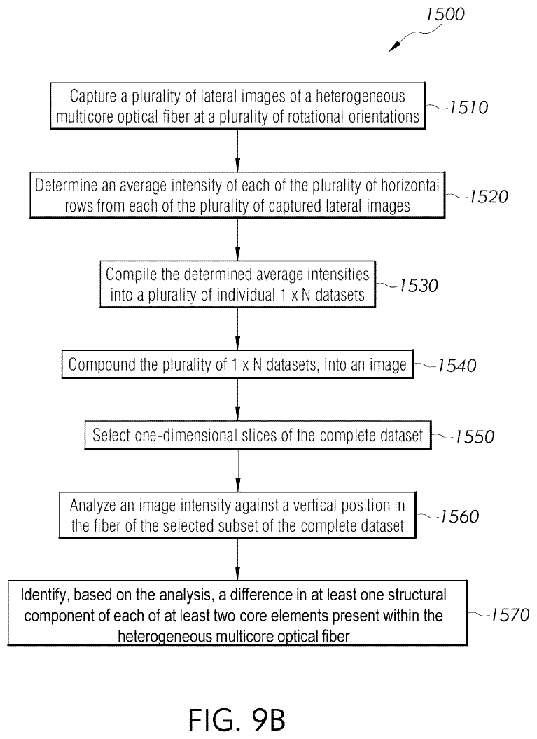

Exemplary processes 1000, 1500 for identifying core elements of a multicore optical fiber using the techniques described with respect to FIGS. 3-I through 8E are shown in the flow charts of FIGS. 9A and 9B. Instructions to execute such processes 1000, 1500 can be downloaded and/or retrofit into a memory of splicing equipment, for example, to facilitate an accurate and time-efficient determination of core element identities while splicing.

More specifically, a process 1000 is shown in FIG. 9A for identifying core elements, such as a first core element and a second core element, of a heterogeneous multicore optical fiber (e.g., the first core element 511 and the second core element 521 of the heterogeneous multicore optical fiber 500 described herein). The process 1000 begins by obtaining, at step 1010, a heterogeneous multicore optical fiber having a first core element having a first core region surrounded by a first dedicated cladding region and a second core element having a second core region surrounded by a second dedicated cladding region. Using an imaging system of splicing equipment, a first lateral image of the fiber at a first particular rotational orientation is captured at step 1020. An average intensity of each horizontal row from the first captured lateral image is then determined at step 1030 using a processor, for example, of the splicing equipment. The determined average intensities from the first image are then compiled at step 1040 in a first vertical 1×N dataset.

Once again using the imaging system of existing splicing equipment, a second lateral image of the fiber at a second rotational orientation is captured at step 1050. The second rotational orientation of the fiber is different than the first rotational orientation of the fiber. An average intensity of each horizontal row from the second captured image is then determined at step 1060 using the processor, for example. The determined average intensities from the second image are then compiled at step 1070 in a second vertical 1×N dataset.

The process 1000 continues by capturing an Xth lateral image of the fiber at an Xth rotational orientation at step 1080. The Xth lateral image can correspond to a fifth lateral image, a tenth lateral image, a hundredth lateral image, a thousandth lateral image, and/or any suitable number of lateral images taken at various rotational orientations. Stated another way, any number of desired lateral images can be captured at a corresponding number of rotational orientations. As with previous captured images, the process 1000 further includes determining an average intensity of each horizontal row from each captured image using the processor at step 1090, for example. The determined average intensities from the captured image are then individually compiled at step 1092 in a vertical 1×N dataset.

In various embodiments, the imaging system can capture all of the images sequentially and then perform analysis of the captured images to extract the desired information. In other embodiments, the imaging system captures one image at a time, performs the necessary analysis of such image, and then collects a subsequent lateral image.

The individual vertical 1×N datasets are compounded at step 1094 into a compounded image over a full fiber rotation. Several one-dimensional slices of the larger dataset (e.g., a subset including at least two datasets) are then selected at step 1096 from the compounded image. An image intensity of such a subset of the larger dataset is then analyzed at step 1098 against the corresponding vertical position of the image intensity in the fiber to distinguish the core elements of the heterogeneous multicore optical fiber. In some embodiments, the core elements may be distinguished based on disposition/placement of the core elements with respect to the centerline of the heterogeneous multicore optical fiber. For example, in some embodiments, the core elements may be distinguished based on the relative distances from the centerline of the heterogeneous multicore optical fiber at which an edge of a structural component of each core element may be disposed, such as the relative distances d₁ and d₂ discussed above with reference to FIGS. 3-I and 3-II. In some embodiments, such disposition/placement or distance difference may be partly due to the size difference in the structural components (e.g., size difference in the outer diameters of the dedicated cladding regions) of the core elements of the multicore optical fiber. Once the relative disposition/placement, relative distance, and/or relative size associated with a structural component of the core elements is identified, the core elements can be identified and distinguished from one another for each end of the multicore optical fibers to be spliced, the multicore optical fibers can be properly aligned and connected.

In various instances, as stated above, it is possible to identify one core element, such as a larger core element (e.g., a core element with a larger dedicated cladding region), from another core element, such as a smaller core element (e.g., a core element with a smaller dedicated cladding region), using a single 1×N dataset. In such instances, the identification of the core elements involves a comparison of a distance between the first horizontal line 660 and the second horizontal line 665 and a distance between the third horizontal line 670 and the fourth horizontal line 675 as shown in FIGS. 4-I and 4II. The larger distance corresponds to the larger core element, and the smaller distance corresponds to the smaller core element.

FIG. 9B depicts an alternate process 1500 for identifying particular core elements of a heterogeneous multicore optical fiber using lateral images. The process 1500 begins by capturing a plurality of lateral images of the heterogeneous multicore optical fiber at a plurality of rotational orientations at step 1510, using an imaging system of splicing equipment. An average intensity of each horizontal row from each of the plurality of captured images is then determined at step 1520 using a processor, for example. The determined average intensities from each of the plurality of captured images are then compiled at step 1530 into a 1×N dataset, forming a plurality of individual 1×N datasets.

The individual 1×N datasets are compounded at step 1540 into a compounded image. A subset of one-dimensional dataset slices of the complete dataset (e.g., a subset of two datasets at 180 degrees rotation apart from each other) are then selected at step 1550 from the compounded image. An image intensity of such a subset of the larger dataset is then compared at step 1560 against the corresponding vertical position of the image intensity in the dataset or compounded image to distinguish the structural components of the core elements of the multicore optical fiber. Based at least in part on such comparison, a disposition/placement difference, size difference, etc., associated with at least one structural component of each core element present within the heterogeneous multicore optical fiber can be identified at step 1570. Once the difference in the structural components, such as the relative disposition/placement and/or size of a dedicated cladding region (e.g., depressed-index cladding region or trench) of the core elements is identified for each end of the multicore optical fibers to be spliced, the multicore optical fibers can be properly aligned and connected such that the same core elements from different fibers are optically coupled.

Alternatively and/or in addition to using lateral image processing to identify core elements of a multicore optical fiber, a process utilizing a single end-face image of a multicore optical fiber can be utilized to differentiate between individual core elements of a heterogeneous multicore optical fiber.

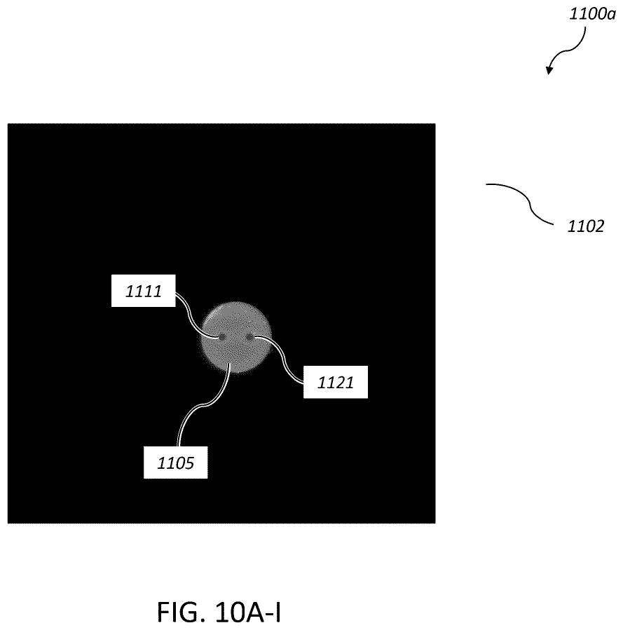

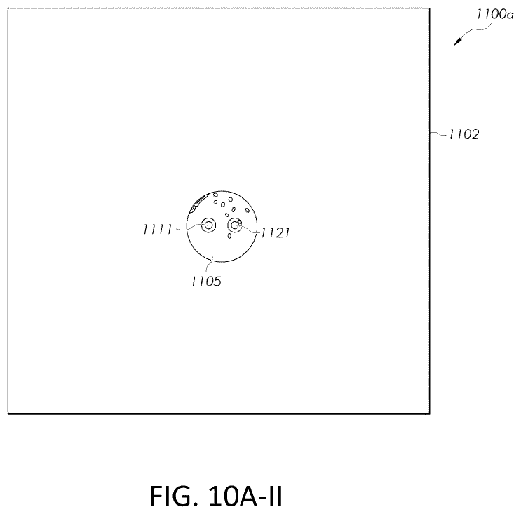

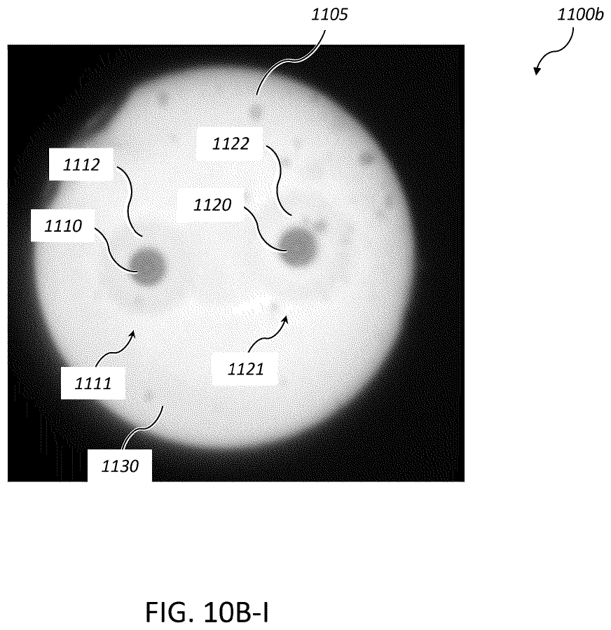

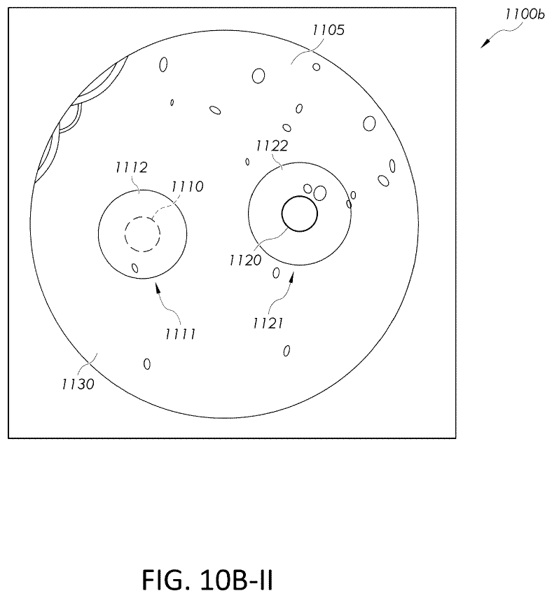

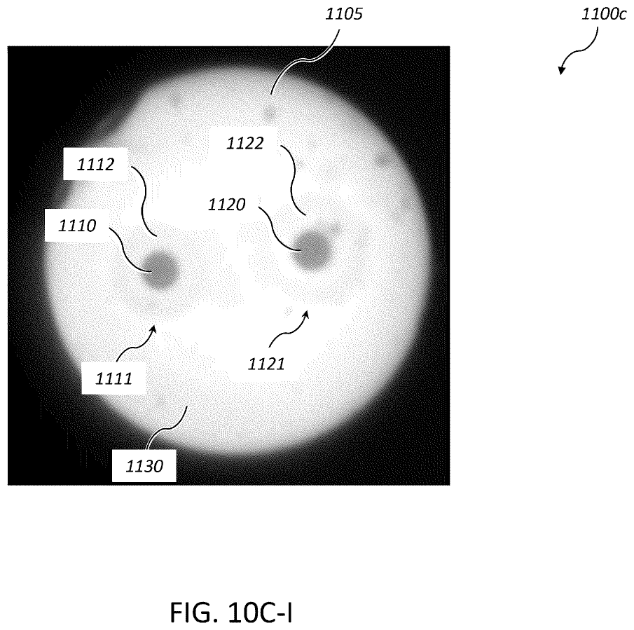

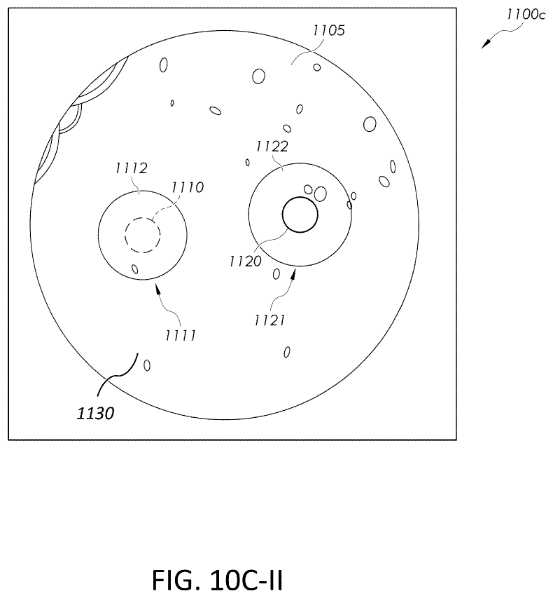

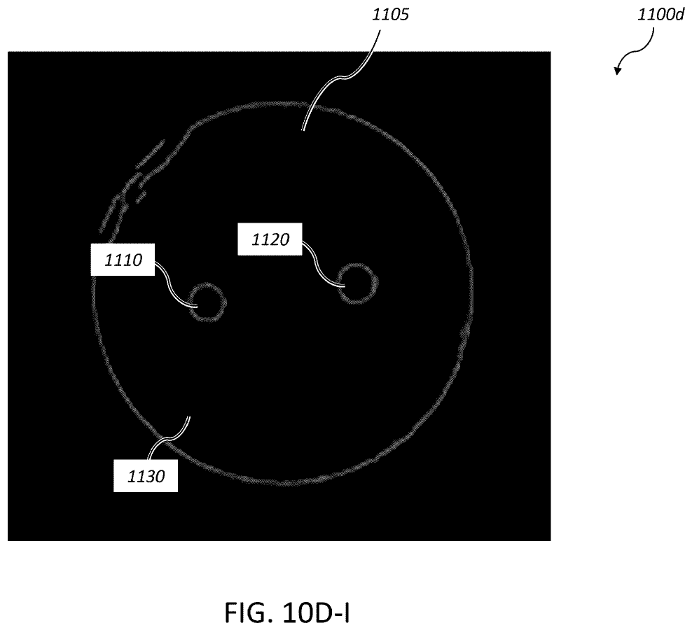

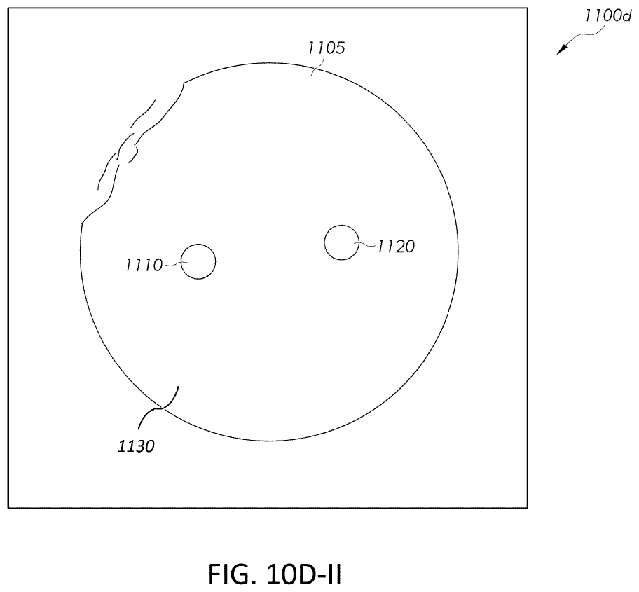

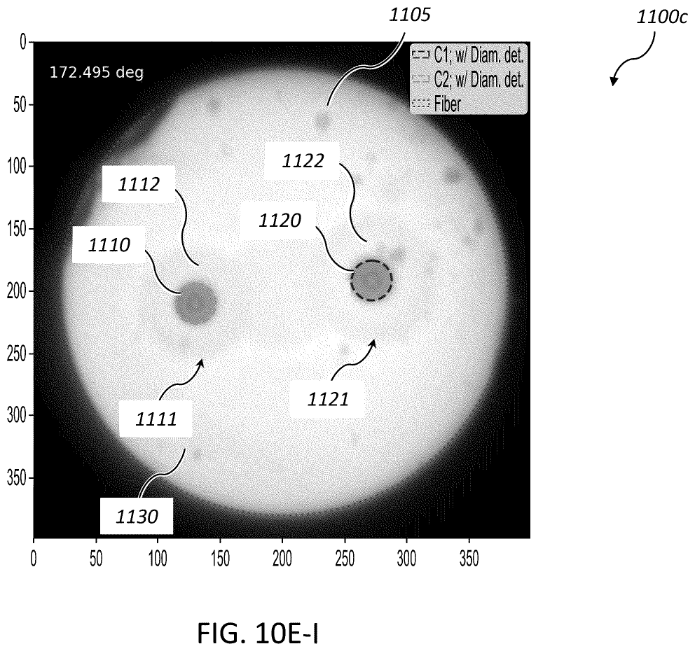

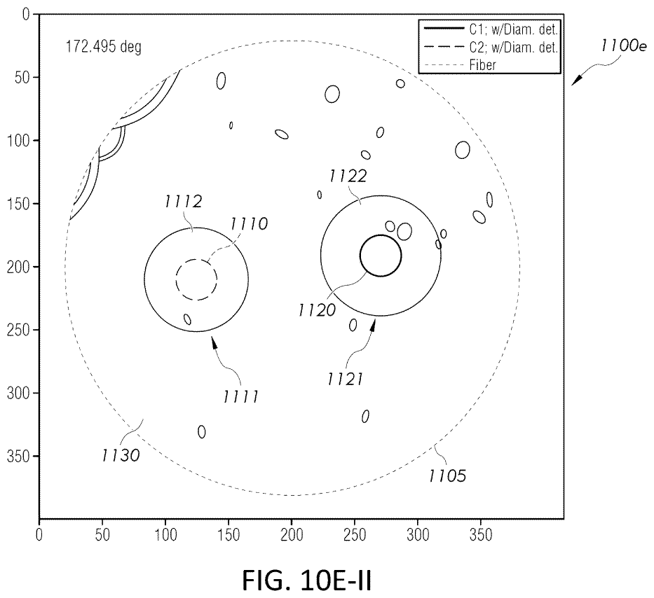

Referring now to FIGS. 10A-I, 10A-II, and 11, splicing equipment is used to capture a single end-face image of a heterogeneous multicore optical fiber. An exemplary end-face image 1100a in gray scale of a heterogeneous multicore optical fiber is shown in FIG. 10A-I, and a line-drawing representation of the end-face image 1100a is depicted in FIG. 10A-II. The captured image 1100a depicts an end-face of a multicore optical fiber 1105 having a first core element 1111 and a second core element 1121. Notably, the captured image 1100a includes a background 1102 to be cropped for further analysis of a portion of the captured image 1100a depicting the multicore optical fiber 1105. In some embodiments, cropping the background 1102 may reduce computation power needed, although such cropping is not required. For example, if the background 1102 is already relatively small in the image 1100a initially captured, cropping may not be needed.

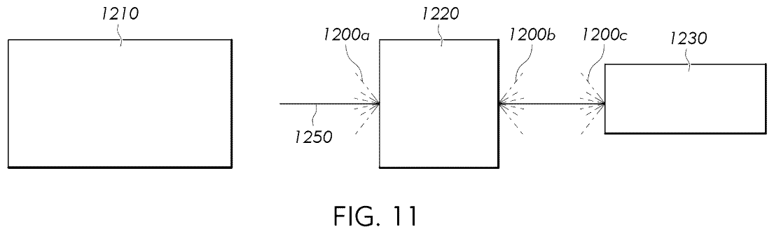

As depicted in FIG. 11, the image 1100a can be captured using splicing equipment. More specifically, a multicore optical fiber 1250, similar in many respects to the multicore optical fiber 1105, can be positioned in splicing equipment. The splicing equipment includes, for example, an imaging system 1210 and a fiber positioning system having a fiber axis 1220. In various instances, the imaging system 1210 includes a camera and an illumination source. In various instances, the fiber positioning system includes a positioning nest that holds a particular fiber during rotation thereof. Various portions along the multicore optical fiber 1250 can be illuminated by the illumination source of the imaging system 1210 for the end-face image capture. Stated another way, core elements within the multicore optical fiber are able to successfully be identified regardless of the portion of the multicore optical fiber 1250 that is illuminated during the image capture step. More specifically, as shown in FIG. 11, one or more illumination or light, sources 1200a, 1200b, 1200c can be directed, or otherwise positioned, to illuminate the multicore optical fiber 1250 at various positions along the multicore optical fiber 1250. For example, the light source 1200a can be directed, or otherwise aimed, toward a first portion of the multicore optical fiber 1250, wherein light is directed at a first end of the fiber axis 1220, adjacent to the imaging system 1210. In various instances, the first end of the fiber axis 1220 corresponds to a window of the fiber axis, where the multicore optical fiber 1250 has minimal wobbling. When the first portion of the multicore optical fiber 1250 is illuminated, only a portion, such as half, of the multicore optical fiber diameter is exposed. In a second, alternative, instance, the light source 1200b is directed, or otherwise aimed, toward a second portion of the multicore optical fiber 1250. The second portion is different than the first portion. In this instance, light is directed toward a second, opposite side of the fiber axis 1220 where wobbling of the multicore optical fiber 1250 is greater than the first portion, for example. When the second portion of the multicore optical fiber 1250 is illuminated, an entirety of the multicore optical fiber diameter is exposed. In yet another instance, the light source 1200c is directed, or otherwise aimed, toward a third portion of the multicore optical fiber 1250. The third portion is different from both the first portion and the second portion. More specifically, in this instance, light is directed in a direction 1230, adjacent the second side of the fiber axis 1220. The multicore optical fiber 1250 is expected to experience a wobbling that is greater than at the first portion but less than at the second portion at the third portion. While only three specific portions of the multicore optical fiber 1250 are discussed in detail herein, a user will be able to successfully identify the core elements of the multicore optical fiber 1250 regardless of the portion of the multicore optical fiber 1250 that is illuminated by the light source 1200a, 1200b, 1200c.

Referring now to FIGS. 10A-I through 14, a process 1600 for identifying core elements of a multicore optical fiber having a plurality of core elements utilizing end-face image analysis is described. As described with respect to FIG. 11, the multicore optical fiber is sufficiently illuminated, an end-face image, such as the image 1100a, is captured in step 1610 by an imaging system of the splicer. In various instances, as shown in FIG. 11, the imaging system includes a charge-couple device (CCD). In other instances, the imaging system includes Complementary Metal-Oxide Semiconductor (CMOS) arrays. However, any suitable imaging system can be utilized to capture the end-face image.

After the image 1100a is captured, core elements of the multicore optical fiber are identified through a multi-stage process. In various instances, each stage utilizes information determined in at least one of the preceding stages of the process, for example. In other instances, various stages, or portions thereof, of the process can be skipped and/or performed out of order. At the outset, as shown in FIGS. 10B-I and 10B-II, respectively, the captured image 1100a shown in FIGS. 10A-I and 10A-II is cropped into an image 1100b. Notably, the cropped image in gray scale is depicted in FIG. 10B-I, while a line-drawing representation of the cropped image 1100b is depicted in FIG. 10B-II. As depicted in FIGS. 10B-I and 10B-II, the first core element 1111 has a first core region 1110 surrounded by a first dedicated cladding region 1112 and the second core element 1121 has a second core region 1120 surrounded by a second dedicated cladding region 1122. The first core region 1110, the first dedicated cladding region 1112, the second core region 1120, the second dedicated cladding region 1122, and/or the heterogeneous multicore optical fiber 1105 include circular cross sections. The first dedicated cladding region 1112 is spaced away from the centerline of the heterogeneous multicore optical fiber 1105 at a first distance as shown in FIGS. 3-I and 3-II as d₁, for example. The second dedicated cladding region 1122 is spaced away from the centerline of the heterogeneous multicore optical fiber 1105 at a second distance as shown in FIGS. 3-I and 3-II as d₂, for example. The first distance is different than the second distance. In the depicted exemplary end-face image, the first distance is less than the second distance. While the first distance is different than the second distance, such difference may not be visually, or otherwise readily, apparent. For example, the difference between the first distance and the second distance may be less than 1 μm. In such instances, the use of image analysis is necessary to be able to accurately identify the core elements of the multicore optical fiber. The multicore optical fiber further includes a cladding region 1130 common to the first and second core elements 1111, 1121.

In various instances, image uniformity of the cropped image 1100b is improved by reducing noise from the captured image, for example. In some embodiments, image uniformity may lead to improvement of image uniformity within various individual regions (e.g., core regions 1110, 1120, dedicated cladding regions 1112, 1122, common cladding region 1130) of multicore optical fiber 1105 shown in the cropped image 1100b. Improvement in the image uniformity within the various regions may allow the boundaries between adjacent regions to become more defined or stand out, thereby improving the accuracy of the detection of such boundaries in subsequent steps, such as detecting the edges of first and second core regions 1110, 1120 and/or distinguishing the edges of the first and second dedicated cladding regions 1112, 1122 using intensity profiles, as will be discussed in more detail below.

As mentioned above, in some embodiments, image uniformity may be improved by noise reduction. In some embodiments, noise reduction may be achieved using, for example, a median filter which is a smoothing technique used to remove noise in smooth patches while preserving the edges of structural components within the image. Stated another way, the smoothing technique is designed to reduce the noise of the image while preserving the captured structural components. In some embodiments, the median filtering process is accomplished by applying a circular window over the image, for example. Edges of structural components are preserved for a particular, predefined circular window size. A desirable circular window size depends on various factors, such as a pixel size and/or resolution of a particular image, for example. The circular window size is selected such that it is not too large to smooth out all image features and that it is not too small to fail to sufficiently smooth out the image. In some embodiments, the circular window size can be approximately half of the core region radius or less than half of the core region radius, for example, so as to preserve the edges of the core regions captured by the image. In some embodiments, the median filter may rank the pixels based on, e.g., pixel value, in a particular neighborhood, or region, for example. In some embodiments, a resultant filtered image may be formed by replacing pixels with a median value of the ranked neighborhood pixels. The median value is calculated by first sorting all of the pixel values from the surrounding neighborhood into numerical order and then replacing the pixel being considered with the middle pixel value. One non-limiting exemplary median filter may include a skimage medium filter. However, any suitable filters or image processing techniques can be used to improve the image uniformity within individual regions so as to facilitate the edge/boundary detection of various regions in subsequent steps. The resultant filtered image 1100c after image uniformity improvement, e.g., by applying a median filter to the cropped image 1100b, is shown in FIGS. 10C-I and 10C-II. Notably, a gray scale resultant filtered image is depicted in FIG. 10C-I, while a line-drawing representation of the resultant filtered image 1100c is depicted in FIG. 10C-II.

Using the filtered image 1100c of FIG. 10C-I, an estimated location of a center of each core element, more specifically, a center of each core region 1110, 1120, can then be detected through a rough, coarse detection. Coarse detection is used to identify the presence of certain patterns, textures, and/or edges in an image. As such, the coarse detection is used at step 1630 to provide a rough estimate for the location or the coordinates of each core element, such as the center of each core region. In various instances, estimated coordinates of each core region 1110, 1120 may be determined based at least in part on a gray scale collapse for each axis and/or the Hough Circle Transform, for example. The Hough Circle Transform is a feature extraction technique used in digital image processing for detecting circles in imperfect images. More specifically, the Hough Circle Transform draws circles at a certain radius by traversing local changes in grayscale transition within the input image 1100c with the help of an accumulator with the background. The point where all of the drawn circles intersect reveals a center of the circle, or the center of the core region 1110, 1120, for example. Upon detecting the rough coordinates of the centers of the core region 1110, 1120, rough coordinates of the center of the multicore optical fiber 1105 may be obtained based on, for example, in some embodiments, a centroid calculation using the rough coordinates of the centers of the core regions 1110, 1120. After the rough coordinates of the centers of the core regions 1110, 1120 and the multicore optical fiber 1105 are obtained, a cladding intensity calculation may be performed on the common cladding 1130 of the multicore optical fiber by averaging grayscale pixels radially from the center of the multicore optical fiber 1105 to the outer edge of the multicore optical fiber 1105. A core intensity calculation may also be performed on each core region 1110, 1120 by averaging grayscale pixels radially from the center of each core region 1110, 1120 to the edge of each core region 1110, 1120. In various instances, averaging the pixels radially from the centers of the core elements to the outer edge of the core elements provides a range to be used for detecting an edge of the core regions.

In some instances, coarse detection image analysis may lack the ability to provide a precise object localization and recognition. A more precise location of the center of each core region 1110, 1120 and/or fine coordinates of each core region 1110, 1120 may be detected at step 1640 through fine core region detection. Edges of each core region 1110, 1120 can be detected using, for example, the Canny Edge filter in OpenCV. Such detection results in the pixels being assigned binary values. Pixels assigned a value of 1 represent an edge, for example. In various instances, the cladding intensity calculated during coarse detection, more specifically, the calculated cladding intensity and/or the calculated core intensity, is used to define a range for assigning binary values during edge detection. The resultant detection of the edges is depicted in the image 1100d shown in FIGS. 10D-I and 10D-II. Notably, a binary image 1100d is depicted in FIG. 10D-I, while a line-drawing representation of the image 1100d is depicted in FIG. 10D-II.

Using the image shown in FIGS. 10D-I and 10D-II, a rectangular area surrounding each identified core region 1110, 1120, is cropped and an XY dataset is extracted from the cropped area for each core region 1110, 1120. The extracted XY dataset is filtered to eliminate outlier pixels that do not follow a circular shape, for example. The outliers can be eliminated through application of a random sample consensus (RANSAC) algorithm, for example, at the edge of each core region 1110, 1120 based on at least in part on the calculated cladding intensity and/or the calculated core intensity. Fine core region coordinates, in particular, the edge and center coordinates, can be calculated by fitting a circle to the filtered XY dataset using the least squares method, for example. In some embodiments, the least squares method, in combination with the RANSAC algorithm, finds the best-fitting curve or line of best fit for a set of data points by reducing the sum of the squares of the offsets of the points from the curve. Such fine detection of the edge and center, or edge and center coordinates, of each core region 1110, 1120 results in the image 1100e shown in FIGS. 10E-I and 10E-II, where the detected edge of each core region 1110, 1120 is marked in a dashed line. Notably, FIG. 10E-I shows the image 1100e in gray scale, while a line-drawing representation of the image 1100e is depicted in FIG. 10E-II. The calculation of the fine core region coordinates (in particular the center) is used later in the image analysis to obtain multiple radial intensity slices and calculate an average radial intensity profile based on the multiple radial intensity slices taken that encompass the dedicated cladding region 1112, 1122. As core regions 1110, 1120 each have a very clear form, using the center of the core region as a starting point for the radial averaging can give an accurate basis for determining a dimension of each core element's dedicated cladding region 1112, 1122, for example.

Although exemplary imaging processing steps and techniques are described herein for purpose of illustration, other processing steps and/or techniques may be implemented for extracting and/or determining the edges of the core regions and/or coordinates of the centers of the respective core regions. Further, as the level of precision in detecting the centers of the core regions increases, finer/smaller differences in the structural components of the core elements can be more accurately detected and distinguished as discussed in more detail below.

Using the image 1100c and/or any of the information previously determined by analyzing the originally-captured image 1100a, an identity of each core element is determined at step 1650, for example, by distinguishing a dedicated cladding region size of each core element within the multicore optical fiber 1105. More specifically, for example, in a multicore optical fiber having two core elements, a first dedicated cladding region size of the first core element is distinguished from a second dedicated cladding region size of the second core element.

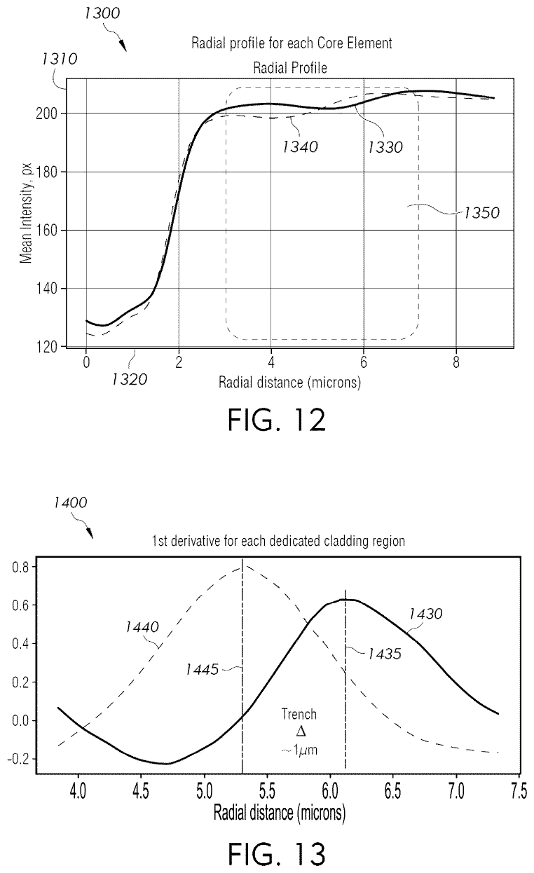

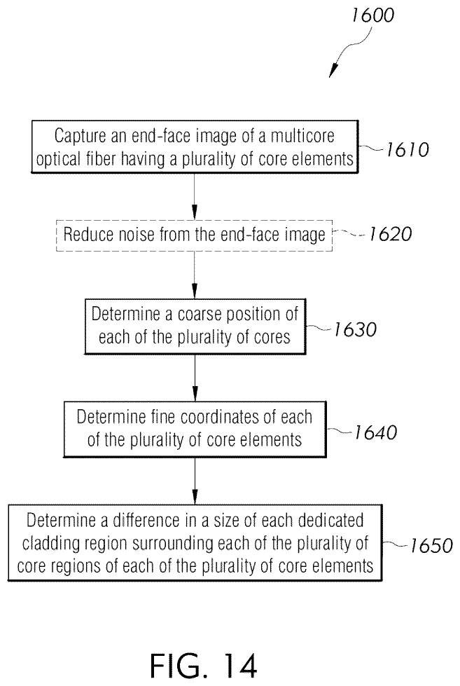

As shown in FIG. 12, using an image, such as the image depicted in FIG. 10C-I, for example, a radial intensity profile 1300 for each core element is determined by plotting a gray scale intensity of each core element 1310 against a radial distance 1320 measured in microns, for example. More specifically, radial profiles for the first and second core elements 1111, 1122 of the multicore optical fiber 1105 depicted in FIGS. 10A-I through 10E-II are represented in FIG. 12. A first radial profile 1330 representative of the first core element 1111 having a first core region 1110 surrounded by a first dedicated cladding region 1112 and a second radial profile 1340 representative of the second core element 1121 having a second core region 1120 surrounded by a second dedicated cladding region 1122 that is larger than the first dedicated cladding region 1112 are depicted in the graph shown in FIG. 12. The radial intensity profiles 1330, 1340 may be obtained by averaging multiple radial intensity slices taken from the center of each core region 1110, 1120 for each core element over a pre-determined distance that exceeds a dedicated cladding region outer radius.

To identify the core elements, a region of interest (ROI) 1350 is established to use in trimming the radial intensity profile for each core element to the region around the determined core element edges. The ROI spans a range sufficient to encompass boundaries of the structural components of the core elements of the multicore optical fiber. In various instances, the ROI is established using at least one dimension, e.g., a diameter of the dedicated cladding region, from a specification provided by a multicore fiber manufacturer.

A derivative 1400 of the trimmed radial intensity profile of each core element with respect to the radial position is calculated and depicted in FIG. 13. More specifically, a first derivative profile 1430 is representative of a first derivative taken of the first radial profile 1330 formed by the relationship between gray scale intensity and radial position, and a second derivative profile 1440 is representative of a first derivative taken of the second radial profile 1340 formed by the relationship between gray scale intensity and radial position. As shown in FIG. 13, a maximum peak of the calculated derivative for each core element is determined. More specifically, a first maximum peak 1435 is identified along the first derivative profile 1430, and a second maximum peak 1445 is identified along the second derivative profile 1440. The derivative profile with a maximum peak located further away from the center indicates a dedicated cladding region of a bigger diameter, for example. More specifically, as the second maximum peak 1445 is identified at a radial distance further away from a center of the core element than the first maximum peak 1435, the second dedicated cladding region 1122 surrounding the second core region 1120 is identified as being larger than the first dedicated cladding region 1112 surrounding the first core region 1110. Such an identification provides an indication of the orientation of the optical fiber to facilitate splicing.

As shown in FIG. 12, the method described herein is capable of identifying the core elements based on a difference in the outer radius of the dedicated cladding region that is about 1 μm as an example. It should be noted that the method described herein may be utilized to identify core elements with regions that have radius difference greater than or equal to 1 μm or less than or equal to (i.e., ≤) 1 μm. In some embodiments, the radius difference between core elements may be≤10 μm, ≤7.5 μm, ≤5 μm, ≤2.5 μm, ≤1 μm, ≤0.8 μm, ≤0.6 μm, ≤0.5 μm, or less. Additionally, although identification of core elements each having only one dedicated cladding region is described as an example, the method described herein may also be utilized to identify core elements with multiple dedicated cladding regions since the derivative profiles may be utilized to determine relative radial positions of the outer edges of the multiple dedicated cladding regions. Since derivative of the intensity profiles are utilized, the method may be capable of distinguishing various dedicated cladding regions where an absolute difference between the relative refractive indices of adjacent cladding regions (e.g., adjacent dedicated cladding regions, or an outermost dedicated cladding region and the adjacent common cladding region) may be less than or equal to (i.e., ≤) 1.5%, ≤1%, ≤0.5%, ≤0.3%, ≤0.1%, or less, or may range from about 0.1% to about 1.5%, from about 0.1% to about 1%, from about 0.1% to about 0.5%, from about 0.1% to about 0.3%, or from about 0.1% to about 0.2%.

The algorithms and processes discussed herein are described as being performed with respect to a first multicore optical fiber. As opposing ends of two multicore optical fibers are joined together during splicing, the algorithms and processes described herein are envisioned as being repeated for the corresponding end of a second multicore optical fiber to facilitate splicing and optically coupling the optical fibers in the desired orientation.

While the specific examples herein are described relative to core elements having a core region and a dedicated cladding region, such as a dedicated depressed index cladding region, for example, it is envisioned that such techniques and/or processes can be used to identify any structural element within the multicore optical fiber. For example, the techniques and/or processes described herein can be used to identify the structural boundaries of a core element having a core region, a dedicated inner cladding region, a dedicated depressed index cladding region, a dedicated outer cladding region, no dedicated cladding regions, multiple dedicated cladding regions, or any combination thereof.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of identifying core elements within a multicore optical fiber, the method comprising:
capturing, by an imaging system, a first lateral image of a heterogeneous multicore optical fiber at a first rotational orientation, the first lateral image comprising a first plurality of horizontal rows, wherein the heterogeneous multicore optical fiber comprises a first core element having a first core region surrounded by a first dedicated cladding region and a second core element having a second core region surrounded by a second dedicated cladding region, the first dedicated cladding region having a first diameter greater than a second diameter of the second dedicated cladding region;
determining, by a processor, a first average intensity of each of the first plurality of horizontal rows;
compiling, by the processor, the first average intensity of each of the first plurality of horizontal rows in a first dataset;
capturing, by the imaging system, a second lateral image of the heterogeneous multicore optical fiber at a second rotational orientation, the first rotational orientation being different than the second rotational orientation, and the second lateral image comprising a second plurality of horizontal rows;
determining, by the processor, a second average intensity of each of the second plurality of horizontal rows;
compiling, by the processor, the second average intensity of each of the second plurality of horizontal rows in a second dataset;
compounding, by the processor, the first dataset and the second dataset into a compounded image;
analyzing, by the processor, an image intensity of the compounded image against a vertical position of the image intensity in the compounded image; and
identifying, based on the analysis, the first core element having the first dedicated cladding region having the first diameter greater than the second diameter of the second dedicated cladding region of the second core element.

2. The method of claim 1, the method further comprising:
selecting, by the processor, at least one dataset from the first dataset or the second dataset from the compounded image.

3. The method of claim 2, wherein the step of analyzing the image intensity of the compounded image against the vertical position of the image intensity in the compounded image comprises:
analyzing, by the processor, the image intensity of the at least one dataset against the vertical position of the image intensity in the compounded image.

4. The method of claim 3, wherein the step of identifying the first core element comprises:
comparing vertical positions associated with at least two image intensity apexes, wherein the at least two image intensity apexes each corresponds to a structural component of each of the first core element and the second core element.

5. The method of claim 4, wherein the structural component comprises an outer edge of each of the first dedicated cladding region of the first core element and the second dedicated cladding region of the second core element.

6. The method of claim 1, the method further comprising:
capturing, by the imaging system, a third lateral image of the heterogeneous multicore optical fiber at a third rotational orientation, the third rotational orientation being different than the first rotational orientation and the second rotational orientation, and the third lateral image comprising a third plurality of horizontal rows;
determining, by the processor, a third average intensity of each of the third plurality of horizontal rows;
compiling, by the processor, the third average intensity of each of the third plurality of horizontal rows in a third dataset; and
compounding, by the processor, the third dataset into the compounded image with the first dataset and the second dataset.

7. The method of claim 6, the method further comprising:
selecting, by the processor, at least two datasets from the first dataset, the second dataset, and the third dataset from the compounded image.

8. The method of claim 7, wherein the step of analyzing the image intensity of the compounded image against the vertical position of the image intensity in the compounded image comprises:
analyzing, by the processor, the image intensity of the at least two datasets against the vertical position of the image intensity in the compounded image.

9. The method of claim 1, wherein a first outer edge of the first core region corresponds to a first horizontal row in the first lateral image, and wherein a second outer edge of the second core region corresponds to a second horizontal row in the first lateral image.

10. The method of claim 1, wherein a third outer edge of the first dedicated cladding region corresponds to a third horizontal row in the first lateral image, and wherein a fourth outer edge of the second dedicated cladding region corresponds to a fourth horizontal row in the first lateral image.

11. The method of claim 1, wherein the first rotational orientation and the second rotational orientation span 180 degrees.

12. The method of claim 1, wherein the first diameter is an outer diameter of the first dedicated cladding region, and wherein the second diameter is an outer diameter of the second dedicated cladding region.

13. A method of identifying core elements within a heterogeneous multicore optical fiber, the method comprising:
capturing, by an imaging system, a plurality of lateral images of the heterogeneous multicore optical fiber at a plurality of rotational orientations, each lateral image of the plurality of lateral images comprising a plurality of horizontal rows;
determining, by a processor, an average intensity of each of the plurality of horizontal rows from each of the plurality of lateral images;
compiling, by the processor, the average intensity of each of the plurality of horizontal rows from each of the plurality of lateral images into a plurality of datasets, each of the plurality of datasets corresponding to one of the plurality of lateral images;
compounding, by the processor, the plurality of datasets into a compounded image;
selecting, by the processor, a subset of the plurality of datasets from the plurality of datasets compounded into the compounded image;
analyzing, by the processor, an image intensity of the compounded image against a vertical position of the image intensity in the compounded image of the subset of the plurality of datasets; and
identifying, based on the analysis, a relative size of at least one structural component of each of at least two core elements present within the heterogeneous multicore optical fiber.

14. The method of claim 13, wherein the plurality of rotational orientations spans 180 degrees.

15. The method of claim 13, wherein the step of compounding the plurality of datasets into the compounded image comprises compounding the plurality of datasets from a full rotation of the multicore optical fiber into the compounded image.

16. The method of claim 13, wherein the heterogeneous multicore optical fiber comprises a first core element and a second core element, the first core having a first core region being surrounded by a first dedicated cladding region having a first diameter, the second core element having a second core region being surrounded by a second dedicated cladding region having a second diameter, and wherein the first diameter is greater than the second diameter.

17. The method of claim 16, wherein the first diameter is an outer diameter of the first dedicated cladding region, and wherein the second diameter is an outer diameter of the second dedicated cladding region.

18. A method of identifying core elements within a multicore optical fiber, the method comprising:
capturing, by an imaging system, an end-face image of the multicore optical fiber, wherein the multicore optical fiber comprises at least two core elements surrounded by a common cladding and each of the at least two core elements has a core region surrounded by a dedicated cladding region;
estimating a location of a center of the core region of each of the at least two core elements;
determining a position of an outer edge of the core region of each of the at least two core elements;
determining a coordinate of the center of the core region of each of the at least two core elements using at least the determined position of the outer edge of the core region of each of the at least two core elements;
analyzing a radial intensity profile of each of the at least two core elements using at least in part the determined coordinate of the center of the core region of each of the at least two core elements; and
identify one of the at least two core elements from another one of the at least two core elements based on the analysis of the radial intensity profile.

19. The method of claim 18, further comprising:
reducing noise in the end-face image prior to the step of estimating the location of the center of each of the at least two core elements; or
calculating a core region intensity of the core region of each of the at least two core elements utilizing the estimated location of the center of the core region of the at least two core elements; or
calculating a cladding intensity of the common cladding utilizing an estimated location of a center of the multicore optical fiber;
wherein the position of the outer edge of the core region of each of the at least two core elements is determined using at least one of the core region intensity or the cladding intensity.

20. The method of claim 18, wherein the dedicated cladding region of one of the at least two core elements has a diameter that is different from a diameter of the dedicated cladding region of another one of the at least two core elements, and wherein analyzing a radial intensity profile of each of the at least two core elements comprises analyzing a derivative of the radial intensity profile of each of the at least two core elements.
